(19) United States
(12) Patent Application Publication
(10) Pub. No.: US 2011/0061555 A1
(43) Pub. Date: Mar. 17, 2011

(54) PLASMA GENERATOR COMPRISING SACRIFICIAL MATERIAL AND METHOD FOR FORMING PLASMA, AS WELL AS AMMUNITION SHOT COMPRISING A PLASMA GENRATOR OF THIS TYPE

(75) Inventors: Lennart Gustavsson, Karlskoga (SE); Ola Stark, Hammaro (SE)

(73) Assignee: BAE Systems Bofors AB, Karlskoga (SE)

(21) Appl. No.: 12/934,169

(22) PCT Filed: Mar. 23, 2009
(86) PCT No.: PCT/SE09/00149

§ 371 Date: Nov. 18, 2010

(30) Foreign Application Priority Data
Apr. 1, 2008 (SE) 0800731-2

(51) Int. Cl. F42B 5/02; B23P 11/02

(52) U.S. Cl. 102/440; 29/446

(57) ABSTRACT

The invention relates to a plasma generator (4, 4′) for electrothermal and electrothermal-chemical weapon systems, which plasma generator is intended to deliver at least one energy pulse for the formation of a plasma for accelerating a projectile (3) along the barrel (11) of the weapon system. The plasma generator comprises a combustion chamber (20) with a combustion chamber channel (20′), a centre electrode (24, 24′) disposed inside the combustion chamber channel, which combustion chamber and centre electrode are electrically conductive, and a ceramic tube (23) arranged between the combustion chamber and the centre electrode. The ceramic tube is shrink-fastened into the combustion chamber, and the plasma generator further comprises a polymeric sacrificial material (34, 34′), which is gasifiable by the energy pulse. The invention also relates to a method for making the plasma generator form a plasma, and an ammunition round having a plasma generator according to the invention.

### TECHNICAL FIELD

The present invention relates to a plasma generator for electrothermal and electrothermal-chemical weapon systems, which plasma generator is intended to deliver at least one energy pulse for the formation of a plasma for accelerating a projectile along the barrel of the weapon system, which plasma generator comprises a combustion chamber having an axial combustion chamber channel, a centre electrode disposed inside the combustion chamber channel, which combustion chamber and centre electrode are electrically conductive, as well as a ceramic tube, arranged between the combustion chamber and the centre electrode disposed inside the combustion chamber, for insulating the centre electrode from the combustion chamber.

The present invention also relates to a method for making a plasma generator for electrothermal and electrothermal-chemical weapon systems form at least one plasma, which plasma is intended to accelerate a projectile along the barrel of the weapon system, which plasma generator has been produced with a combustion chamber having an axial combustion chamber channel, a centre electrode having been disposed inside the combustion chamber channel, which combustion chamber and centre electrode are electrically conductive, and a ceramic tube for insulating the centre electrode from the combustion chamber having been arranged between the combustion chamber and the centre electrode disposed inside the combustion chamber.

The invention also relates to an ammunition shot comprising a plasma generator for electrothermal and electrothermal-chemical weapon systems, which plasma generator is intended to deliver at least one energy pulse for the formation of a plasma for accelerating a projectile along the barrel of the weapon system, which plasma generator comprises a combustion chamber having an axial combustion chamber channel, a centre electrode disposed inside the combustion chamber channel, which combustion chamber and centre electrode are electrically conductive, as well as a ceramic tube, arranged between the combustion chamber and the centre electrode disposed inside the combustion chamber, for insulating the centre electrode from the combustion chamber.

### BACKGROUND OF THE INVENTION, PROBLEM DEFINITION AND PRIOR ART

In a conventional barrel weapon, i.e. here a weapon which comprises a barrel and in which weapon a projectile is fired and propelled along the barrel by a propellent charge which is ignited with the aid of a percussion primer/priming cartridge, such as, for example, in artillery ordnance, in tank and other combat vehicle guns, in anti-aircraft defense, etc., an attained higher initial velocity (V₀) for the projectile is utilized to, for example, increase the range of the weapon, improve the penetrability of the projectile and reduce the period of flight of a projectile in order thereby to make it easier to attack targets which make avoidance manoeuvres. By percussion primer is meant a priming device which either mechanically or electrically ignites the propellent charge. By initial velocity (V₀) is here meant the velocity of the projectile as it leaves the barrel muzzle of the weapon, therefore also hereinafter referred to as the muzzle velocity (V₀) of the weapon. By propellent charge is meant a deflagrating compound or deflagrating agent, hereinafter referred to as a propellant, for example a gunpowder, in the form of a charge which, upon combustion, releases propellent gases, which propellent gases form a strong gas overpressure inside the barrel and which gas overpressure forces the projectile towards the barrel muzzle. The higher is the gas overpressure and the longer-lasting is the effect of this gas overpressure upon the barrel projectile, the higher can be the muzzle velocity.

Great efforts have been made and continue to be made to obtain a higher and higher such muzzle velocity (V₀) for all barrel projectiles, regardless of type, in order to further improve the aforementioned advantageous parameters. For example, the muzzle velocity (V₀) can be raised by enlarging the propellent charge for each ammunition shot, so that a greater quantity of energy can thus be utilized to propel the projectile. The increase in velocity which is thereby possible is, however, relatively limited. One reason for the limited increase in velocity is that an extra quantity of supplied propellent charge, inclusive of the thereby formed propellent gases, has also to be accelerated together with the projectile, so that some of the energy from the extra quantity of supplied propellent charge is used for this, at the same time as all the propellent charge which is unburnt when the projectile leaves the barrel provides no increase in velocity, since the gas overpressure drops to the ambient atmospheric pressure as soon as the projectile has left the barrel. There can also be a problem in being able to fill conventional ammunition shots with all the quantity of propellent charge which is required to attain the desired muzzle velocity and, at the same time, to accommodate the actual projectile without heavily increasing the total weight of the ammunition shots. If the propellent charge accommodated inside the ammunition shot does not have a burning time equivalent to the length of the barrel, the maximum velocity of the projectile can thus already be reached before the projectile has left the barrel, since the propellant manages to burn itself out beforehand.

Thus the optimal propellent charge, regardless of the size of the propellent charge and the attained propulsion velocity of the propellent charge, must burn as fast as the time it takes to drive the projectile out of the barrel, so that a limiting factor for the maximum size of the propellent charge is the barrel length of the weapon. At the same time, it is also the case, of course, that the longer is the barrel, the heavier and more unwieldy is the weapon, so that the desired manoeuvrability of the weapon and the total weight of the weapon in turn limit the optimal barrel length and the material length of the barrel. Together with the material properties of the material with respect to, for example, compressive strength, fatigue, wear, etc., the material thickness of the barrel gives the maximally permitted barrel pressure Pₘₐₓ of the barrel.

In order to prevent the gas overpressure from becoming so large that the barrel is damaged, i.e. that the maximally permitted barrel pressure for the barrel is exceeded, which in the worst case could mean that the barrel is burst, the capacity of the propellent charge to generate propellent gas during the actual ignition of the propellent charge and at the start of the propulsion of the projectile through the barrel is therefore kept to a relatively low level, so that the volume of the initially generated propellent gas is small compared with the total gas volume which has been generated once the propellent charge has finished burning as the projectile leaves the barrel muzzle.

In order to compensate for a space behind the projectile accelerated by the propellent gases, which space steadily increases inside the barrel, and to prevent an unwanted pressure loss, which would otherwise ensue from the increased space and which would unwanted pressure loss which would otherwise ensue from the increased space, which pressure loss would arise if the gas overpressure were not constantly maintained at the said maximally permitted barrel pressure by higher accelerating gas formation via the increasingly rapid combustion of the propellent charge, the quantity of generated propellent gas per unit of time must therefore increase very strongly throughout the propulsion through the barrel, so as to reach its maximum just before the projectile leaves the barrel (see examples of pressure curves in FIG. 8).

An accelerating gas formation of this type can be realized through the use of different so-called progressive propellent charges, i.e. propellent charges having a combustion process in which the propellent charge burns increasingly rapidly towards the end of the combustion process, whereby more and more propellent gas is formed ever more quickly.

The propulsion velocity and acceleration of the projectile thus increases in line with the acceleration of the combustion process and gas formation, wherein the maximum muzzle velocity (V₀) for the projectile with each particular barrel length would be optimized if the gas pressure behind the projectile throughout the course of the propulsion through the barrel were the same as the maximally permitted barrel pressure Pₘₐₓ of the barrel.

A pressure curve over time for an optimal combustion process would therefore exhibit a virtually immediate pressure increase to Pₘₐₓ, followed by a lengthy plateau phase with a maintained constant barrel pressure at Pₘₐₓ throughout the time for which the propellent charge is burning inside the barrel, i.e. the said burning time of the propellent charge, so as then to fall immediately to zero as the projectile leaves the barrel. All the propellent charge will normally then have burnt up. Certain types of shell can however be equipped with so-called base-bleed units, in which the shell is propelled over a further distance, with the aid of a small gunpowder gas motor, even after the shell has left the barrel.

A known way of obtaining the said progressive propellent charge is to use various types of propellant mixtures in the same propellent charge, in which more and more chemically progressive propellants are ignited and burnt the further forward in the barrel the projectile has been driven, which then produces the desired increasingly rapid combustion and the accelerating propellent gas formation during the burning time available for the barrel length. The propellent charge can also be chemically surface-treated with so-called inhibitors, so that the combustion of the propellent charge proceeds more slowly at the start until the surface treatment has burnt up, whereafter the remainder, i.e. the untreated part of the propellent charge, burns without hindrance, so that a propellent charge which initially is actually more powerful than Pₘₐₓ can be utilized.

Another way of producing a progressive propellent charge is by gradually increasing the free burning surface of the propellent charge during the actual combustion thereof by multiperforating the various charge units of the propellent charge with a greater number of burning channels, so that a so-called multihole gunpowder is obtained. These burning channels are arranged at a predefined mutual distance apart, with a certain depth into the propellent charge or passing continuously through it, with a certain set cross section, and are arranged in certain set patterns in order to be able, via the thereby realized combustion of the propellent charge, to increase the free burning surface available for the combustion not only from the outside of the propellent charge but also from the inside of the burning channels. The burning surface inside the burning channels increases strongly as the burning channels are gradually widened as a result of the combustion. The greater the increase in burning surface, the faster is the combustion of the propellent charge and thus the higher and higher is the so-called progressivity.

By varying the mutual distances, the depth, the cross section and the pattern of the said multiperforation, supplemented by the said use of diverse inhibitors, it is attempted to control the acceleration of the propellent gas formation in a manner which is desired for the propulsion of the projectile and to do such that the propellent charge manages to burn itself out within the desired burning time, i.e. just as the projectile leaves the barrel muzzle.

Yet, in spite of the aforementioned efforts to improve the current conventional propulsion methods and the propellent charges which are utilized for these, the practically possible upper limit for the muzzle velocity in the conventional barrel weapons, and then also for the chemically progressive, inhibited and perforated multihole gunpowders, has been reached at about 1500-1800 m/s. This is due to the fact that the chemical progressivity of the currently known propellent charges has an upper limit and since the multiperforation of the constituent propellent charges cannot currently be carried out, however finely powdered. Moreover, these measures, inclusive of the said inhibition, are not very easy to pre-calculate and execute such that the desired pressure curve, for each fired type of propellent charge, always remains exactly the same each time. It will be appreciated that the firing accuracy of the projectile is impaired if the muzzle velocity cannot always be predetermined for each fired shot. The maximum muzzle velocity depends, however, on the particular weight of the projectile, so that the limits vary in dependence on the ammunition type, for example the lower muzzle velocity above here relates to dart ammunition with 40 mm calibre.

There is therefore a strong desire to come up with new propulsion principles and new ammunition of different type than the above-described purely combustion-gas-driven propulsion of the ammunition, which propulsion principles and which new ammunition give the desired considerably higher initial velocity for the fired projectile, i.e. a velocity at the outlet of the barrel of around 1800-2500 m/s, depending on ammunition type and calibre, and this assuming an unchanged projectile weight and total weight for the particular ammunition. The said new ammunition relates, for example, to armour-piercing dart ammunition intended for varying weapon systems comprising a number of different calibres.

A number of new propulsion principles of this type are currently under development for producing the said desired higher initial velocity for different sorts of projectiles. The main division of these propulsion principles is based on whether the propulsion occurs by means of gas drive, via electrical drive or via combinations of these two propulsion methods.

Examples of said gas drive are, on the one hand, where the propulsion is based on traditional combustion gas drive but where the projectile also has an accompanying extra propellent charge for the generation of propulsion gases also outside the barrel, for example the aforementioned base-bleed unit, and, on the other hand, where gases other than gunpowder gases, such as reactive or inert gases, are utilized for the gas drive. By inert gas is here meant a gas which does not normally participate in any chemical reaction occurring in the gas drive.

Examples of electrical drive are substantially fully electrically driven rail or coil guns. Typical of these electrically driven weapon systems are that they are intended to utilize electromagnetic pulses for the propulsion of custom-made projectiles.

Examples of combinations of the said two main principles for the propulsion of projectiles are constituted by, on the one hand, electrothermal propulsion (ET), in which the supply of electrical energy to a narrow, tubular combustion chamber produces a material ablation from the inside of the combustion chamber, which ablation, possibly together with the said inert and/or energetic gas, forms a very hot, electrically conductive plasma and thus a large overpressure for the driving of the projectile, and, on the other hand, electrothermal-chemical propulsion, (ETC), see, for example, U.S. Pat. No. 7,073,447, in which the chemical energy from the combustion of the propellent charge which is present in this case is utilized together with the additional electrothermal energy supplied according to the above.

Once a substance has been heated to form the plasma, the component parts of the molecules are separated, that is to say: the sub-molecules or electrons move freely in relation to one another, and the nucleus of the substance, so that both positive and negative, and thus electrically conductive ions/charges are formed. Somewhat more concisely, it can be said that an ETC weapon is constituted by an at least partially gunpowder-gas driven weapon, in which the total propulsion energy for the projectile receives at least a somewhat basic energy boost via the supply of extra electrical energy from a high-voltage source via the plasma formed inside the combustion chamber. A gunpowder-gas driven gun which is only fired by means of an electrical glow ignition of the propellent charge does not therefore constitute an ETC gun.

In the hitherto known electrothermal-chemical weapon systems, the conventional percussion primer is replaced with a plasma generator comprising the said combustion chamber. An immediate advantage is that the ignition is more temporally exact compared with the traditional percussion primer in which the reaction time for the ignition varies. The plasma generators can be divided into two separate main types, whereof one type, hereinafter referred to as a plasma jet burner, delivers a singular axial plasma jet out of the free end orifice of the plasma jet burner, whilst the other type comprises a radially multipole tube similar to a flute, and therefore also referred to as a “piccolo”, having a number of openings for the plasma arranged along the shell surface of the tube. The “piccolo” normally has no end orifice opening, so that, compared with the plasma jet burner, the same powerful plasma jet which is directed forwards in the longitudinal direction of the plasma jet burner cannot be formed. Both types of plasma generator comprise an electrically conductive conductor for the formation of the plasma, which electrically conductive conductor is heated, gasified and ionized via a very powerful, short electrical energy pulse, whereupon the produced plasma flows out through the openings of the tube, or the end orifice opening of the plasma jet burner, with a very high pressure and temperature, normally several hundred MPa, preferably round about 500 MPa, and in which the temperatures vary between high and extremely high temperature, i.e. normally between about 3000° K and 50000° K, in which 3000° K represents the temperatures reached with the conventional chemical propellent charges. Preferably, however, the plasma temperatures lie between about 10000° K and 30000° K.

The very high temperature of the plasma affects the combustion of the propellent charge in several positive ways. For example, at the said plasma temperatures, a much more complete combustion of the propellants of the propellent charge is obtained than is the case at the normally considerably lower temperatures of the conventional combustion. This as the propellants are converted into the plasma to a higher degree, since the propellants are broken down into smaller molecules, whereby more energy is extracted from the same quantity of propellent charge. This increased energy quantity thus gives the sought-after additional increase in muzzle velocity for the projectile.

Since the propellent charge, moreover, burns faster at the higher temperature of the plasma, a larger propellent charge has time to be burnt before the projectile leaves the barrel, so that the propellent charge quantity can be increased, provided that the cartridge case has space for this, for each given ammunition shot, and thus a further increased energy quantity is obtained for the raising of the muzzle velocity. Specially produced gunpowder types with greater density, higher energy content and lower molecular weight for the propellent gases, which gunpowder types are not normally used or cannot be ignited with conventional percussion primers, can be utilized.

Due to the very high temperature and also the very high internal pressure inside the plasma generator, the combustion chamber of the plasma generator, as well as the barrel, will be subjected to very large heat and load stresses. These stresses are directly dependent on the pulse length and amplitude of the electrical energy, a long pulse length, i.e. the period of duration of the electrical energy pulse, generating more heat and greater stresses than a short pulse length. The long pulse length is disadvantageous, however, with respect to the supplied greater quantity of energy for the acceleration of the projectile, so that a solution to this heat problem is to provide the channel walls of the combustion chamber with an internal, highly heat-resistant insulating material, for example a ceramic which is also electrically insulating. It is previously known to utilize on the inside of a barrel, and in various positions in the longitudinal direction of the barrel, ceramic coatings or inserts to prevent the transfer of electrical energy from an electrical primer to a barrel body, which, however, entails quite different problem solutions than for the prevention of heat and load stresses inside plasma generators.

However, document U.S. Pat. No. 4,957,035, for example, shows an ET weapon comprising a ceramic multichannel, conical plasma jet burner, which is screwed in the back piece of the ET weapon and in which a light arc is generated between a rear centre electrode and a front annular electrode in each ceramic combustion chamber channel. A very hot plasma under high pressure is thereby produced in the combustion chamber channels connected to the barrel, which pressure drives the projectile disposed in the barrel out of the same. The highly heat-resistant and electrically insulating ceramic walls of the combustion chamber channels protect against the extreme heat and electrically insulate the two electrodes from each other, and the combustion chamber channel from the rest of the plasma jet burner.

The ceramics are characterized by a relatively good compressive strength, but they have a low strength otherwise. In particular, the ceramics have a low tensile strength. The very high internal pressure, round about 500 MPa, inside the ceramicized combustion chamber channels, which is caused by the hot plasma, results in an expansion of the ceramic against the walls of the combustion chamber channels. If there happens to be any clearance at all between the ceramic and the walls of the combustion chamber channels, or if the combustion chamber channels yield, i.e. are expanded, to the pressure, tensile stresses will inevitably arise in the ceramic. In the aforementioned plasma jet burner, U.S. Pat. No. 4,957,035, these tensile stresses would easily tear apart the ceramic and cause serious leakage of heat, current, voltage and/or plasma, resulting in inevitable damage to the weapon, if the strength of the plasma jet burner had not been mechanically improved via the axial force with which the conical plasma jet burner is screwed into a corresponding conical and inflexible space and is thus clamped tight. The intention is that this mechanical squeezing into the conical space of the plasma jet burner, at least to a certain extent, will attempt to counteract the said tensile stresses in the ceramic, which has not, however, been wholly successful.

In another shown embodiment, an attempt has been made to further reinforce and seal the plasma jet burner by winding a fibreglass plastic around its outside. Despite these measures, this conical screw fastening nevertheless gives an unsatisfactory result. In particular, the problems with the clearances between the ceramic and the walls of the combustion chamber channels, which clearances are formed by material irregularities and fault tolerances, and with the fact that the mutually interacting conical components must be very precisely made in order to fit together without play, thereby making the components expensive to produce, still persist.

It will be appreciated, moreover, that as a result of the conical shape, something has in principle been designed that can best be likened to a champagne cork which is merely awaiting an increase in internal pressure in order for the whole construction to explode.

The conical screw fastening therefore constitutes an expensive and, in production engineering terms, time-consuming and complicated way of solving the problems with the tensile stresses in the ceramic. In the second shown embodiment, the aforementioned negative parameters are further aggravated with the outer fibreglass plastic winding, which fibreglass plastic winding can best be likened to a further emergency measure taken in a laboratory construction.

Since the ceramic is electrically insulating, moreover, in the currently known plasma generators of this type there is a need for an electrically conductive conductor, generally a metal filament or metal foil, between the electrodes to allow the start-up of the electrical light arc and the plasma subsequently formed by means of the electrical energy. Since this electrical conductor is gasified into gaseous form with the start-up and disappears from the plasma generator, and the ceramic prevents ablation from the channel walls, a continued electrical energy supply is made more difficult or prevented should the plasma cool or die down. Moreover, even with just somewhat longer pulse lengths, of just a few milliseconds, such extremely high temperatures arise that the plasma generator risks suffering damage in spite of the ceramic. At the same time, it is desirable to have the facility, via a long-lasting plasma, to precisely control the combustion of the propellent charge and the electrical energy supplied to the propulsion gases. The aforementioned conical construction quickly becomes leaky and thus unusable, so that the construction constitutes a disposable weapon.

In order to precisely be able to control the supply of electrical energy and thus be able to further raise the muzzle velocity of an ETC weapon, there is therefore a strong desire to find a safe way, in a ceramically electrically insulated combustion chamber channel of a plasma generator, both to ensure the plasma generation and to heavily extend the pulse length, ideally at least tenfold in relation to hitherto possible pulse lengths, at the same time as the plasma generation and the longer pulse length must not be allowed to crack the ceramic, and this without the construction becoming expensive or undesirably complicated.

A further basic problem with the currently customary ETC weapons is that they utilize the barrel as a counter electrode, so that these constructions also impart current or voltage to the actual barrel and thus to other basic parts of the particular weapon system. In addition to obvious drawbacks with this, such as the risk of personal injury due to the electrical danger and short-circuiting of the weapon system, it will be appreciated that there is a substantial risk of a metallic cartridge case being welded fast in the barrel when current and voltage is transmitted to the weapon. Moreover, sensitive electronic equipment can be damaged by unwanted electrical transmissions and ensuing magnetic fields.

Patent specification U.S. Pat. No. 6,186,040 describes a known plasma jet burner for electrothermal and electrothermal-chemical gun systems, in which necessary current and voltage is transmitted to the plasma jet burner via its rear part and then onward to the actual barrel. In one of the shown embodiments, the said metallic cartridge case is instead made of a non-conductive material, but as the barrel is utilized as a counter electrode the barrel will continue to be live and the cartridge case is in this case at risk of fusion.

A further serious effect with the shown construction is that the contact surface between the electrical connectors of the weapon, disposed in the back piece, and the corresponding connectors of the plasma jet burner is minimal, so that the recoil and other vibrations of the weapon during use of the weapon give rise to a small clearance between the said connectors, so that a light arc can be generated which welds the connectors together. The whole of the weapon is therefore at risk of becoming a disposable weapon which can only be fired once.

### OBJECT OF THE INVENTION AND ITS CHARACTERIZING FEATURES

One object of the present invention and its various embodiments is to provide a substantially improved plasma generator for electrothermal and electrothermal-chemical weapon systems, comprising a ceramic tube for insulating the centre electrode from the combustion chamber, and a substantially improved method for making a plasma generator of this type for electrothermal and electrothermal-chemical weapon systems form at least one plasma, which plasma generator and which method substantially reduce or wholly eliminate the aforementioned problems and then, in particular, the problems due to the ceramic in the combustion chamber channel.

A further object of the present invention and its various embodiments is to provide a substantially improved plasma generator for electrothermal and electrothermal-chemical weapon systems and a substantially improved method for repeated firing of the said plasma generator, which plasma generator and which method substantially reduce or wholly eliminate the problems of the ceramic preventing ablation from the walls of the combustion chamber channel and therefore hindering or preventing a continued plasma formation and a resumed electrical energy supply should the plasma cool or die down, the beneficial effects of the plasma generator being able to be put to better use than previously to attain increasingly high muzzle velocities for varying types of projectile.

In addition, it is a further object of the present invention and its various embodiments to provide a substantially improved plasma generator for electrothermal and electrothermal-chemical weapon systems and a method for repeated plasma formation in such a plasma generator, which plasma generator and method can achieve considerably more and longer pulse lengths and plasma life.

At the same time, it is a further object of the present invention and its various embodiments to provide a substantially improved plasma generator for electrothermal and electrothermal-chemical weapon systems and a method for forming plasma in the said plasma generator, which plasma generator and method, moreover, can allow more pulse intervals during the course of propulsion of the projectile through the whole of the barrel, and this regardless of the length of the barrel, and thereby to achieve at least one controllable, longer-lasting, energy-richer plasma and thus to be able to more precisely control the electrical energy supplied to the propulsion gases, the combustion of the propellent charge and the final muzzle velocity for each fired projectile.

It is also an object of the present invention and its various embodiments to provide a substantially improved plasma generator for electrothermal and electrothermal-chemical weapon systems, which plasma generator substantially reduces or wholly eliminates the problems with current and voltage being imparted to the barrel etc., or with the fact that the electric current finds its way through the construction with resultant short-circuiting, as well as the burning fast of the cartridge case in the said barrel.

The said objects, and other aims which are not listed here, are satisfactorily met within the scope of that which is stated in the present patent claims.

Thus, according to the present invention, an improved plasma generator for electrothermal and electrothermal-chemical weapon systems has been provided, which is characterized in that the ceramic tube is precompressed via a shrink-fastening and in that the plasma generator further comprises at least one polymeric sacrificial material, which is gasifiable by the at least one energy pulse and which is disposed inside the ceramic tube.

According to further aspects of a plasma generator according to the invention:

the sacrificial material is gasifiable only to the thickness of one surface coating or layer via the delivered at least one energy pulse;

the sacrificial material is gasifiable to the thickness of a further surface coating or layer for each new energy pulse;

the sacrificial material has a total thickness which is divided into a number of separate, concentric layers laminated one on top of the other, which number of layers and their thickness, material and desired characteristics are dimensioned and selected and preassembled into a laminated sacrificial material tube according to an estimated consumption requirement per delivered energy pulse for a certain type of ammunition shot and ETC weapon for the attainment of a layer-by-layer gasification of the laminated sacrificial material tube;

the sacrificial material is gasifiable for at least the period for which the plasma is maintained or newly created via new energy pulses;

the sacrificial material is gasifiable for at least the whole of the period for which the projectile is propelled through the barrel;

the gasifiable polymeric sacrificial material is comprised of at least one material which in the formed plasma disintegrates into ions, in which the sum of the atomic masses for the atoms in the formed ion (the molecular mass) is lower than or equal to 30 u (30 g/mol);

the at least one gasifiable polymeric sacrificial material is comprised of a material which in the formed plasma forms electrically charged particles with a mass which is lower than or equal to 30 u, i.e. the formed ions have an atomic or molecular mass≦30 g/mol;

the gasifiable polymeric sacrificial material is comprised of at least one dielectric material comprising hydrocarbons, for example thermoplastics, for example polyethylene, fluoroplastic (such as polytetrafluoroethylene, etc.) etc., polypropylene or thermosetting plastics, such as polyester, epoxy or polyimides etc.;

the gasifiable polymeric sacrificial material has a melt temperature of at least 150° C.;

the gasifiable polymeric sacrificial material has a gasification temperature of at least 550° C., preferably over 800° C.;

the gasifiable polymeric sacrificial material has a thermal conductivity of no higher than 0.3 W/mK;

the sacrificial material has a thickness of about 1-6 mm;

the centre electrode is disposed inside the ceramic tube, and which centre electrode, in addition to the at least one gasifiable polymeric sacrificial material, comprises firstly an electrically conductive centre connector, and secondly at least one electrical conductor arranged between the front end of the combustion chamber and the centre connector;

the centre connector also comprises a front pin, on which pin the sacrificial material is fixed;

the centre connector is fitted inside the rear part of the ceramic tube via a shrink-fit;

the gasifiable polymeric sacrificial material is comprised of at least one material which in the formed plasma forms ions which have a lower molecular mass than the heavier metal ions formed by the at least one electrical conductor;

the sacrificial material is disposed along a specific part of the centre electrode, preferably between the front end of the combustion chamber and the centre connector;

the sacrificial material is fixed against the ceramic tube by means of an adhesive;

the sacrificial material is comprised of at least one mass which, in at least one cylindrical surface coating or layer, is solidified in the combustion chamber channel, which at least one mass comprises a space for at least one electrical conductor;

at least one electrical conductor is enclosed and fixed in a plastic mass;

the plasma generator comprises an axially disposed end orifice opening for the delivery of a singular axial plasma jet out of the combustion chamber of the plasma generator;

the ceramic tube and the sacrificial material are axially fixed and axially clamped in the combustion chamber channel via a body comprising the end orifice opening;

the plasma generator comprises a plurality of openings arranged radially along the shell surface of the combustion chamber for a radial delivery of plasma jets out of the combustion chamber of the plasma generator;

the sacrificial material is sublimating.

The improved method for making a plasma generator for electrothermal and electrothermal-chemical weapon systems form at least one plasma according to the present invention is characterized in that the plasma is formed by at least one delivered energy pulse gasifying at least one surface coating or layer of a polymeric sacrificial material which has been disposed inside the ceramic tube, which ceramic tube has been shrink-fastened and hence precompressed to withstand a number of successive energy pulses.

According to further aspects of a method according to the invention:

the plasma is maintained or newly created by further sacrificial material being gasified via new energy pulses;

the thickness and material characteristics of the sacrificial material, such as its gasification temperature and thermal conductivity, have been chosen such that only a certain surface coating or number of layers is converted into plasma per electrical energy pulse;

the plasma is maintained or newly created by the sacrificial material being gasified via new energy pulses at least throughout the period in which the projectile is propelled through the barrel;

the number of energy pulses, the interval between the energy pulses, the pulse length, the current intensity and the voltage which are utilized during the course of propulsion of the projectile through the barrel are varied according to the particular conditions at the moment of firing, whereby an energy supplied to the plasma is controlled;

a pressure deterioration which occurs at a disadvantageous temperature is actively compensated via the supplied energy, whereby a desired temperature and pressure can be attained according to the particular requirements of the existing ambient and propulsion gases;

the plasma generator supplies an energy boost which is geared to and is added to a chemical energy which is obtained upon combustion of a propellent charge, so that the supplied energy and the obtained chemical energy together achieve the quantity of energy which is required in order to achieve and maintain a specific barrel pressure for the particular weapon system during the course of propulsion of the projectile through the barrel;

the thickness of the surface coating converted into the plasma is corresponded to by the energy boost which is required at the energy pulse moment to compensate for the particular pressure reduction in the barrel at the said moment in order to regain the set barrel pressure for the barrel;

the sacrificial material is built up in advance in defined layers with respect to material and desired characteristics, each such layer, given a tailor-made energy pulse at a certain predefined pulse interval, providing a desired energy boost for maintaining the set barrel pressure for the barrel;

the set barrel pressure is constituted by the maximally permitted barrel pressure for the barrel;

the sacrificial material is poured in liquid state into the ceramic tube, whereafter the sacrificial material is solidified;

an axial recess is created in the solidified sacrificial material tube;

new sacrificial material is applied and is solidified in the recess inside the previously applied sacrificial material, whereafter a new axial recess is created in the last applied sacrificial material, which process is repeated until a desired number of layers of sacrificial material has been created;

the axial recess in the sacrificial material is created by the liquid sacrificial material solidifying around a pull-out element, or by boring;

at least one electrical conductor has been disposed inside the ceramic tube along the entire length of the sacrificial material, so that an electrical connection is created over the entire length of the ceramic tube;

the first energy pulse converts at least the at least one electrical conductor into plasma, the following energy pulses converting at least one outer surface coating or layer of the sacrificial material into further plasma, whereby a number of successive energy pulses are generated from the plasma generator even after the electrical conductors have been consumed;

the plasma is made to flow out of the plasma generator with a pressure of between about 200 and 1000 MPa and with a temperature between about 10 000° K and 30 000° K;

each energy pulse is of at least 10 kJ and is supplied to the plasma with a pulse length of at least 1-10 milliseconds per energy pulse;

each energy pulse has a voltage of about 5-50 kVolt;

each energy pulse has a current intensity of between 5 and 100 kA.

The ammunition shot according to the present invention is characterized in that it comprises a plasma generator according to the invention, and in that the plasma generator of the ammunition shot is intended to form at least one plasma by means of a method according to the invention.

### ADVANTAGES AND EFFECTS OF THE INVENTION

The inevitably high plasma temperatures in the plasma generator make it necessary for the combustion chamber channel walls to be protected by the insertion of an insert made of, or by the lagging of the combustion chamber channel walls with, a highly heat-resistant ceramic. Moreover, the ceramic is significantly more leak-tight than an insulation made of, for example, fibreglass, since fibreglass insulation more easily lets through the current in the space between the fibreglass threads.

Via the shrink-fastening of the ceramic inside the combustion chamber channel according to the invention, by the clearances, which are otherwise formed by material irregularities and fault tolerances, between the ceramic and the walls of the combustion chamber channels are removed or at least heavily reduced and by which shrink-fastening the ceramic insert/lagging/tube becomes so precompressed by the contraction of the enclosing combustion chamber during the shrinkage that the tensile stresses which subsequently arise in the ceramic in the formation of the plasma are less than the precompression or are so much counteracted that the resulting stresses in the ceramic are lower than the maximally permitted tensile stresses for the ceramic, the problems with easy cracking of the ceramic under the very high tensile stresses which would arise in the ceramic in the formation of one or more plasma(s) are satisfactorily resolved.

Since the improved plasma generator allows a plurality of successive energy pulses, which are withstood by the ceramic in the combustion chamber by virtue of its precompressed shrink-fastening, which gives an even higher temperature, and hence pressure, than was previously possible, a faster and more complete propellent charge combustion can be obtained and then, moreover, by more modern, more energetic propellent charges, since the propellants of these more modern propellent charges can now not only be ignited, but can also be converted into even smaller molecules than previously, whereupon yet more energy is extracted from the same propellent charge quantity, so that the maximally possible muzzle velocity for the particular barrel weapon therefore increases.

The previous problems of the ceramic preventing ablation from the combustion chamber channel walls and of the glow wire, which acts as a catalyst for initiation of the plasma process, burning up under the first energy pulse and therefore substantially impeding or wholly preventing a continued plasma formation and a resumed electrical energy supply should the plasma cool or die down are tackled according to the invention via the placement of the specially selected gasifiable sacrificial material inside the ceramicized combustion chamber channel.

The chosen sacrificial material is not gasified wholly under the first energy pulse, but is evaporated layer-by-layer, surface coating by surface coating, see FIG. 11, for each new electrical energy pulse, in which the sacrificial material, upon combustion of the same, releases molecules, atoms and/or ions with low molecular weight, i.e. the molecules and the atoms have a lower weight (≦30 u) than the heavier metal ions (>30 u) which are normally utilized in known plasma generators, which light molecules, atoms and/or ions participate in and facilitate the plasma process and the ignition of the propellent charge. Even if the plasma is allowed to cool between the energy pulses, the plasma generator can nevertheless be fired, since the sacrificial material remains, such that new layers or surface coatings can be gasified by the next energy pulses.

In, for example, a preferred embodiment in which the sacrificial material is comprised of a polymer, such as a plastic tube, for example a polyethylene tube, molecules and atoms of the said polymer, which are ionized upon the formation of the plasma, are obtained, which ions primarily comprise various carbon and hydrogen ions, which are lighter than the metal ions formed by the electrical conductor.

The problems of achieving the desired considerably longer pulse lengths, i.e. pulse lengths longer than 1-10 milliseconds, substantially higher energy content in each energy pulse and the sought-after, appreciably extended plasma life, without the onset of such high temperatures that the plasma generator is damaged despite the ceramic tube, are countered by the fact that, in addition to the ceramic, the sacrificial material has such a high gasification temperature and such low conductivity that the chosen sacrificial material, despite considerably longer pulse length, manages to be gasified only to the thickness of a certain surface coating, or layer-by-layer, for each new electrical energy pulse. By virtue of the fact that the sacrificial material manages to be gasified only to the extent of one surface coating or layer for each new pulse, the sought-after, appreciably extended plasma life is obtained and the temperature, which would otherwise be harmful to the plasma generator, is cooled by the continuous supply of light ions.

Moreover, more energy pulses and pulse intervals are enabled during the course of propulsion of the projectile through the whole of the barrel, whereby the electrical energy supplied to the propulsion gases can be more accurately controlled. More pulses give the chance of constant pressure at Pₘₐₓ for a many times longer period. The stresses which are directly dependent on the pulse length of the electrical energy, i.e. the period of duration of the electrical energy pulse, diminish if the electrical energy can be divided into a number of pulse intervals, which pulse intervals then generate less heat and fewer stresses than a single long pulse length. The combined pulse length can then be considerably longer than previously. By virtue of the shrink-fastening according to the invention, the ceramic combustion chamber insert of the plasma generator, in the form of the ceramic tube, copes with the vibrations which occur, partly due to the use of the weapon and its recoil and partly due to the said plurality of successive energy and pressure pulses, with which current ceramic plasma generators are unable to cope since they do not precompress the ceramic. Moreover, ceramic components disposed in an ammunition shot and a plasma generator, for example in the form of a ceramic tube, can be damaged during the handling of these, so that a precompressed and shrink-fastened ceramic tube reduces these handling risks.

If the ambient temperature or temperature of the propellent gases is disadvantageous, it is also possible to temperature-compensate for this in a much simpler manner, i.e. the pressure deterioration which occurs at a colder temperature can be actively compensated, since the quantity of electrical energy, and thus the desired temperature and the pressure, can be varied according to the particular requirements. The total pressure curve which is obtained for the particular barrel when a shot is discharged can thus be tailored such that the said pressure curve does not exceed the permitted maximum pressure of the barrel and such that the pressure in the barrel distributed over time is always as perfect as possible, i.e. normally that the individual pressure curves mutually overlap in such a way that the pressure troughs of the total pressure curve are minimized. A further advantage with this is that the safety margin for Pₘₐₓ in the dimensioning of the barrel can be reduced.

The fact that a plurality of energy pulses, see FIG. 8, are sent one after the other through the plasma generator means that the same number of plasma jets will be formed by the sacrificial material and squirt out of the plasma generator, in which each of these plasma jets gives a sufficient boost to the temperature and thus to the pressure in the barrel such that the barrel pressure from the formed propellent gases attains essentially immediately and is substantially maintained at a level directly below Pₘₐₓ, which level is desired for the particular barrel, for a substantially longer period than previously and preferably substantially directly after the firing, and thereafter throughout the propulsion process through the whole of the barrel. The sought-after maximum acceleration of the projectile, defined by Pₘₐₓ, is thus obtained for a significantly longer part of, or even the whole of, the firing process. This is possible since the electrical energy supplied via the plasma generator is geared to or is added to the chemical energy obtained in the progressive combustion of the propellent charge, so that the supplied electrical and the developed chemical energy together always attain the energy level which is required to maintain the maximally permitted barrel pressure for the particular weapon. In previously known plasma generators, in which only a single energy pulse is delivered, and then mostly to ignite the propellent charge, the maximally permitted barrel pressure is not reached directly upon firing, but rather this is gradually attained due to progressive combustion of the propellent charge, or else the barrel pressure starts to fall or vary as soon as the electrical pulse and thus the plasma jet has burnt itself out due to the difficulties which there are in getting the propellant to always burn evenly and in a controlled manner throughout the combustion process, this despite a very complicated and expensive dimensioning and production of the progressive propellent charges.

### LIST OF FIGURES

The invention will be described in greater detail below with reference to the appended figures, in which:

FIG. 1 is a schematic perspective view of an ammunition shot for an electrothermal-chemical weapon system, which ammunition shot incorporates a plasma generator according to the present invention.

FIG. 2 is a schematic longitudinal section through parts of the ammunition shot according to FIG. 1, which ammunition shot comprises the plasma generator, parts of a propellent charge and a projectile enclosed in a cartridge case.

FIG. 3 is a schematic longitudinal section through parts of an electrothermal-chemical weapon according to a first embodiment for firing the ammunition shot according to FIG. 1 by means of a plasma generator according to FIG. 4.

FIG. 4 is a schematic longitudinal section through parts of a plasma generator according to a first embodiment of the invention.

FIG. 5 is a schematic perspective view of a turret for a combat vehicle, in which combat vehicle an electrothermal-chemical weapon system comprising a plasma generator according to the invention is used.

FIG. 6 shows schematically a perspective view of an alternative cartridge case for use with the ammunition shot comprising a plasma generator according to the invention.

FIG. 7 is a schematic longitudinal section through the cartridge case according to FIG. 6.

FIG. 8 shows schematically pressure curves relating to a firing of a plasma generator according to the invention.

FIG. 9 shows a schematic longitudinal section through parts of a second embodiment of the plasma generator according to the invention, comprising connectors of the lamellar contact type.

FIG. 10 is a schematic longitudinal section through parts of an electrothermal-chemical weapon, according to a second embodiment, for firing an ammunition shot by means of the plasma generator according to FIG. 9.

FIG. 11 is a schematic cross section through parts of a plasma generator according to the invention, in which is shown the corresponding half cross-section of the concentrically arranged combustion chamber, ceramic tube, sacrificial material tube and electrical conductors in the solidified plastic mass. The sacrificial material tube is also shown comprising a plurality of layers or, symbolically, the surface coatings which are burnt off, one for each energy pulse.

### DETAILED DESCRIPTION OF EMBODIMENTS OF THE INVENTION

With reference to FIG. 1, a perspective view of an ammunition shot 1 for an electrothermal-chemical (ETC) weapon system, also hereinafter referred to as an ETC shot, is shown schematically, preferably comprising armour-piercing dart ammunition for use in, for example, tanks, combat vehicles and various anti-tank weapons, but also for use in, for example, fighter aircraft, anti-aircraft weapons and other artillery.

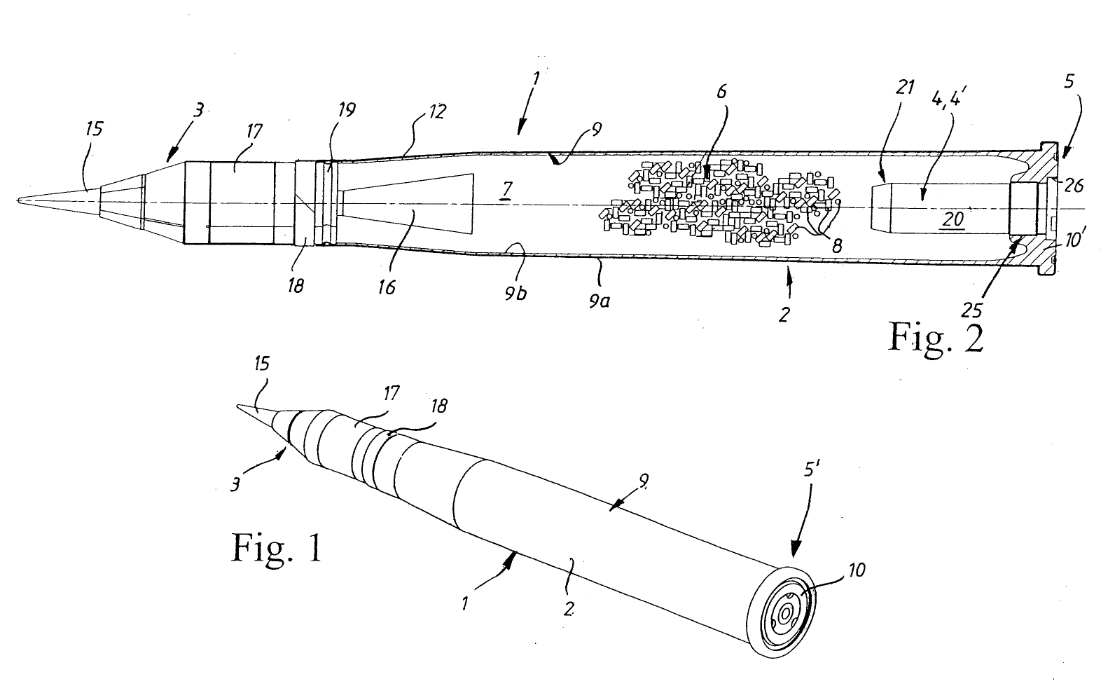

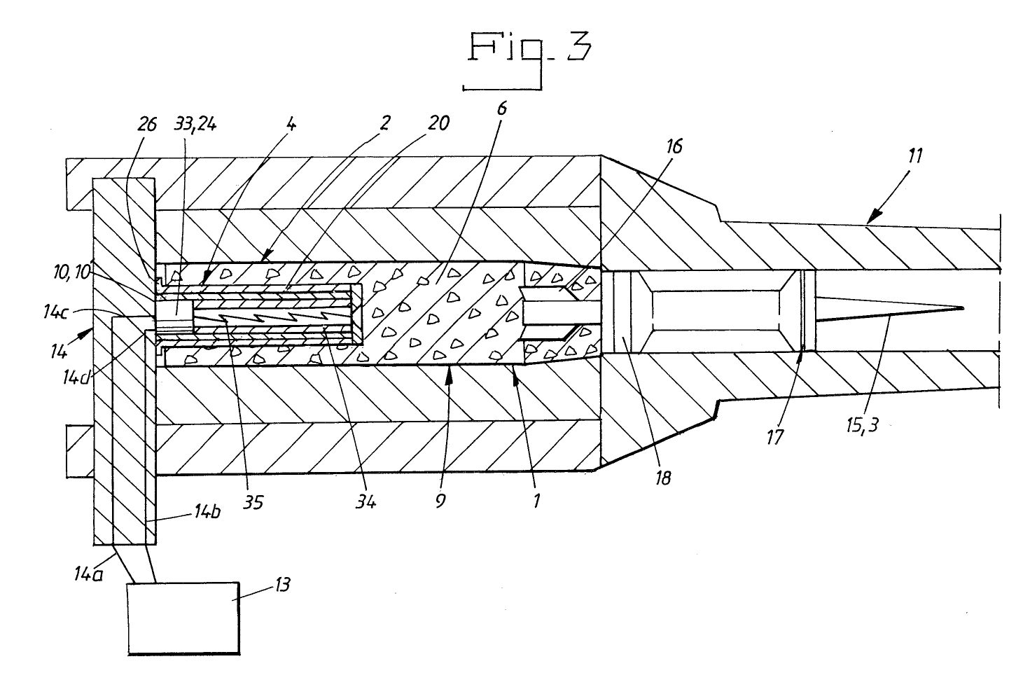

In FIG. 2 is shown a schematic longitudinal section through parts of a first embodiment of the ammunition shot 1 according to FIG. 1, which ammunition shot 1 comprises a cartridge case 2, a front projectile 3, a plasma generator 4, for forming a plasma according to the present invention, disposed on the rear end 5 of the ammunition shot 1, and parts of a propellent charge 6 enclosed in the cartridge case 2. The propellent charge 6 is indicated only schematically in the middle of the cartridge case 2, but preferably the whole of the cavity 7 of the cartridge case 2 is filled with the propellent charge 6.

The propellent charge 6 is here comprised of granular gunpowder, also referred to as gunpowder pellets 8, for example a compacted NC gunpowder granular charge. The said gunpowder pellets 8 have often first been treated with a suitable chemical to produce an adhesion between the individual gunpowder pellets 8, whereafter the gunpowder pellets 8 are compressed into the propellent charge 6 desired for the particular cartridge case 2 and having a desired shape defined by the cavity 7.

The propellent charge 6 can also be comprised (not shown) by a solid gunpowder comprising at least one charge unit in the form of one or more cylindrical rods, discs, blocks etc., which charge units have been multiperforated with a greater number of burning channels, so that a so-called multihole gunpowder is obtained, and which charge unit or charge units together substantially hold, or fill, the internal dimensions of the cartridge case 2. Alternative embodiments of the propellent charge 6 also comprise multiperforated double-base (DB) gunpowder with inhibition, Fox 7, ADN, nitramine, GAP, etc. known gunpowder types, or a suitable liquid propellant (not shown).

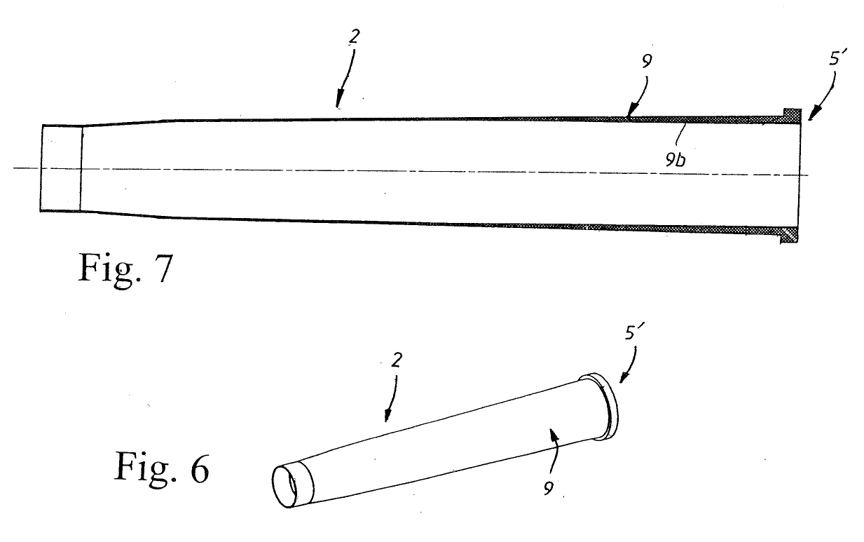

The casing 9 of the cartridge case 2, see FIGS. 2, 6 and 7, is preferably comprised of an electrically insulating material, i.e. dielectric or non-conductive, for example a fibre composite (see FIGS. 6 and 7), or else the casing 9 comprises a combination of different materials, in which at least one outer 9a and/or inner 9b coating or surface is electrically insulating (see FIG. 2).

In the embodiment of the cartridge case 2 which is shown in FIG. 2, this comprises a metallic casing 9 to which a plastic forming a thicker outer coating 9a and a thinner inner surface 9b has been applied for electrical insulation of, respectively, the outside and inside of the casing 9 in relation to at least the barrel 11 of the weapon system, see especially FIG. 3, and preferably also to the plasma generator 4. In the production of such a cartridge case 2, the casing 9 can be comprised, for example, of a conventional metal case, to which metal case a plastic is bonded by vaporization methods, whereupon an outer and/or inner protective plastic film coat with a thickness of about 20-70μ is formed. The thicker outer coating 9a can also be constituted by an outer shrinkable tubing 12, which has been placed over the casing 9, the outer dielectric coating 9a or directly on top of the propellent charge 6. In the embodiment shown in FIG. 2, the cartridge case 2 also comprises a bottom 10′, which is integrated with the rest of the casing 9 of the cartridge case 2, i.e. is made from and of the same material as the rest of the casing 9. It will be appreciated that the said material can also be an inherently electrically insulating material.

In the embodiment of an electrically insulating casing 9 which is shown in FIGS. 6 and 7, this is here constituted by a rigid, wound, fibre-reinforced thermosetting plastic, for example by epoxy plastic, cured polyethylene, etc., having the outer shape of a cartridge case 2 intended for the particular weapon. Following forming of the casing 9, this is ground to the desired thickness and a loose bottom piece 10 (see especially FIG. 1) is disposed at the rear end 5′ of the casing 9. The said bottom piece 10 is fastened to the rest of the casing 9 in a tight-fitting manner by means of threading, gluing or by means of some other joint (not shown in detail) appropriate to the function. The bottom piece 10 can therefore be unscrewable from the rest of the casing 9 or can be permanently fastened thereto. The bottom piece 10 can be made of a metallic material, which in that case is expediently insulated around its peripheral part via its fastening in the insulated casing 9 or via dielectric coating. Preferably, however, the bottom piece is made of the same insulating material as the electrically insulating casing 9.

The said bottom piece 10 or bottom 10′ and the plasma generator 4 bear against the wedge, screw or back piece of the weapon, see FIG. 3, whereby the plasma generator 4 is in electrical contact with a high-voltage source 13, the polarity of which can be shifted, via electrical connections 14a, 14b comprising connectors in the form of input and output conductors 14c, 14d. Since the cartridge case 2, i.e. the casing 9 and preferably also the bottom piece 10 or the bottom 10′, apart from the actual plasma generator 4, comprises or is comprised of one or more materials which do not conduct current or voltage over to the barrel 11 and the wedge 14, there is no or only minimal risk of the cartridge case 2 burning and sticking fast in the particular weapon/gun due to an electrical short-circuit.

In one embodiment (not shown), it is also conceivable for the shrinkable tubing to be arranged directly on top of the propellent charge without an inner, rigid casing. The shrinkable tubing is here arranged such that it extends between the projectile and the bottom piece, with a rigidity necessary for the ammunition function, with the aid of the propellent charge and/or via vacuumization of the powder bag thus formed. Following firing of such an ammunition shot, in this embodiment only the metal bottom piece and/or plasma generator is left, the rest is burnt in the barrel.

In the embodiments of the ammunition shot 1 which are shown in the figures, see especially FIG. 2 and FIG. 3, the projectile 3 is comprised of a sub-calibre, fin-stabilized, armour-piercing dart 15 with guide cone or guide fins 16, which dart 15 is at least partially enclosed in and supported inside the casing 9 by a multipart dart-supporting body referred to as the sabot 17. Arranged around the sabot 17 is a girdle 18 for sealing the ammunition shot 1 against the inside of the barrel 11. A joint 19 in the form of, for example, grooving, see FIG. 2, gluing etc. connects the projectile 3 to the casing 9 of the cartridge case 2. Armour-piercing dart ammunition normally acquires its considerable effect from the fact that the dart 15, preferably, has an appreciable weight (density about 17-20 g/cm³, such as, for example, tungsten) and that it is fired at high velocity, so that the additional high velocity which is attainable with the present invention represents a major advantage.

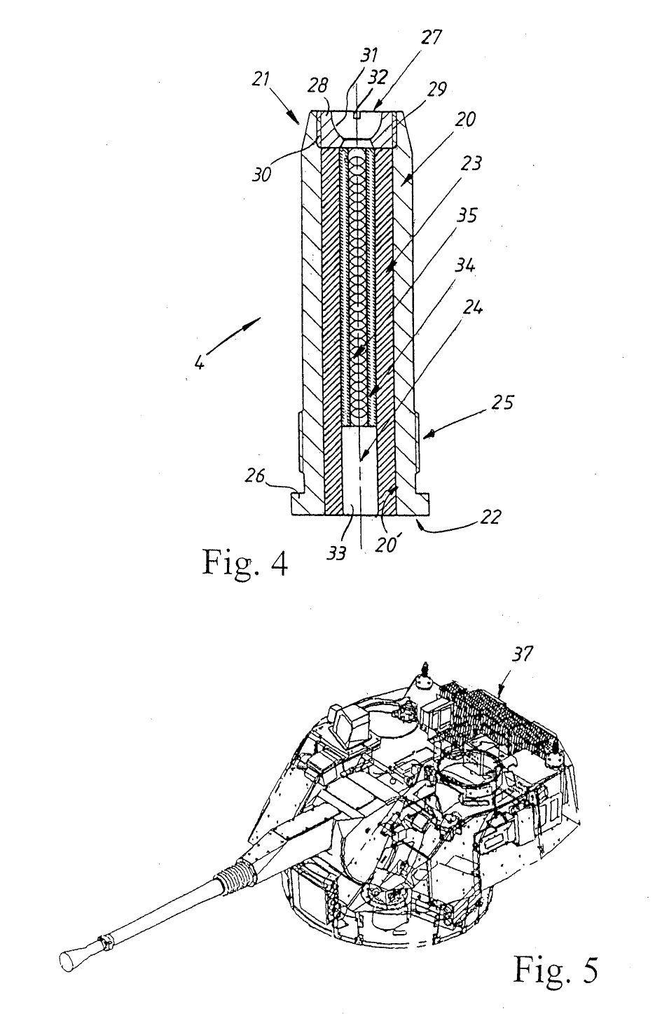

The plasma generator 4, in the embodiment shown in FIG. 4, which constitutes the equivalence of the ETC shot 1 to a conventional percussion primer, comprises an outer shell in the form of a tubular and electrically conductive, expediently metallic combustion chamber 20 having a front 21 and a rear 22 end, which outer shell, furthermore, is concentrically mounted inside the centric channel 20′ of the combustion chamber 20, which centric channel 20′, hereinafter also referred to as the combustion chamber channel 20′, passes axially through the said combustion chamber from end to end 21, 22, an electrical and thermal insulation in the form of a dielectric, highly heat-resistant ceramic insert, ceramic coating or other ceramic unit, preferably a ceramic tube 23, and an innermost centre electrode 24, which is disposed in the back of the centric channel 20′ and is enclosed by the ceramic tube 23. The ceramic tube 23 has a high temperature stability, i.e. is dimensioned to withstand very high temperatures, without cessation of its function, of up to a maximum peak temperature of at least about 50 000° K and an operating temperature of between about 10 000° and 30 000° K for at least the time for which the plasma is maintained or newly created via new energy pulses, and preferably for at least the whole of the time for which the projectile 3 is propelled through the barrel 11.

The said ceramic tube 23 is fitted inside the combustion chamber 20 via a shrink-fit, also referred to as shrink-fastening, i.e. by a heating and thus expansion of the metallic combustion chamber 20 and, possibly, a cooling and thus a slight shrinkage of the ceramic tube 23, whereby a sufficient tolerance is created between the combustion chamber 20 and the ceramic tube 23 to allow the ceramic tube 23 to be fitted inside the combustion chamber 20 in spite of the inner diameter of the combustion chamber 20 at normal temperature being less than the outer diameter of the ceramic tube 23. Following cooling of the combustion chamber 20 to the same temperature as the ceramic tube 23, the ceramic tube 23 enclosing the combustion chamber 20 will thus have contracted just enough that not only does the ceramic tube 23 sit quite tight along the whole of its outer surface against the inside of the combustion chamber channel 20′, so that the occurring clearances, formed by material irregularities and fault tolerances, between the ceramic and the walls of the combustion chamber channels are removed, possibly with a sealing compound or plastic material, for example metallic or ceramic, therebetween, which evens out all diameter variances, fault tolerances and irregularities and spreads the load, but also the ceramic tube 23 acquires a certain, precisely defined precompression through the shrinkage of the combustion chamber 20.

This precompression gives the ceramic tube 23 a strongly increased capacity to cope with the very high internal pressure, and thus the tensile stresses in the ceramic material which always arise during the plasma formation inside the combustion chamber channel 20′. The precompression of the ceramic tube 23 by the combustion chamber 20 is dimensioned such that the subsequent tensile stresses which arise in the ceramic during the plasma formation are less than the precompression, or are so much counteracted that the resulting stresses in the ceramic are lower than the maximally permitted tensile stresses for the ceramic. The ceramic tube 23 is expediently clamped in place with a clamping force of around 300 MPa-1000 MPa, preferably 500 MPa-700 MPa. The ceramic tube 23 comprises one or more ceramic materials, preferably of titanium oxide, zirconium dioxide, aluminium oxide or silicon nitride or the like. The shrink-fitting and precompression of the ceramic tube 23 in the aforementioned manner also gives several other advantageous characteristics. In the shrink-fitting, the tolerance requirement between the constituent parts is less than in a direct fitting, where the fit must be extremely precise, which gives a considerably cheaper production of the plasma generator 4, in addition to which the otherwise inevitable empty space which would otherwise have to be present between the ceramic tube 23 and the combustion chamber 20 is eliminated. If the ceramic tube 23, due to a poor fit against the combustion chamber 20, were forced to alone bear the internal compressive loads imparted from the plasma, and the tensile stresses which would then arise in the ceramic material, the risk of fracture would increase dramatically, as ceramics normally have a considerably lower tensile strength than compressive strength.

The plasma generator 4 is either fixed to the bottom 10′ integrated with the casing 9 of the cartridge case 2, see FIG. 2, or to the bottom piece 10 arranged removably with the casing 9, see FIG. 1, which bottom 10′ or bottom piece 10 is preferably either made of dielectric material or else is coated with such material. For example, in the embodiment shown in FIG. 2, the combustion chamber 20 is arranged projecting from the rear end 5 of the cartridge case 2 and detachably fastened to the bottom 10′ by means of an external thread 25. The thread 25, see FIG. 4, is arranged in connection with the rear end 22 of the combustion chamber 20 and within a, i.e. in the direction of the front end 21, flange 26, which flange is arranged there circumferentially and projects out from the combustion chamber 20. Preferably, the sole parts of the ammunition shot 1 behind the girdle 18 of the projectile 3 which are in conductive contact with the weapon are constituted by the said flange 26 together with the metallic connector 33 of the centre electrode 24, hereinafter referred to as the centre connector. As the girdle 18, too, can be made of plastic, the ammunition shot 1 is very well electrically insulated.

An orifice closure 27, see FIG. 4, in the form of a cylindrical body 28, acting as a front annular electrode interacting with the centre electrode 24, is disposed in the combustion chamber channel 20′ at the front, somewhat bevelled end 21 of the combustion chamber 4, axially outside and coaxially with the shrink-fitted ceramic tube 23 and the centre electrode 24. The cylindrical body 28 comprises an external thread 29 for fitting of the orifice closure 27 to the combustion chamber channel 20′ provided with corresponding internal thread 30. The orifice closure 27 further comprises a centric, nozzle-shaped end orifice opening 31 passing continuously through the cylindrical body 28, having a diameter which increases towards the front end 21 of the combustion chamber 20 to produce a plasma jet widening function towards the rear end of the propellent charge 6, and thus a better ignition and combustion of the propellent charge 6. Also shown is a groove 32 for a turning tool in the outer transverse surface of the cylindrical body 28, allowing the orifice closure 27 to be easily screwed to the front end 21 of the combustion chamber 20.

The centre electrode 24 comprises the metallic, in the embodiment shown in FIG. 4, cylindrical centre connector for “input” electrical connection, which centre connector 33 is fitted inside the rearmost part of the ceramic tube 23 via shrink-fitting (the centre connector 33 is expediently cooled in nitrogen −196° C., whereby a sufficient temperature difference arises relative to the ceramic tube 23 to allow shrink-fitting to take place), a sacrificial material 34 disposed between the centre connector 33 and the orifice closure 27, expediently in the form of a tube, therefore also referred to as the sacrificial material tube 34, fixed inside and against the inside of the ceramic tube 23, and at least one, but preferably a plurality of electrical conductors 35 disposed inside the sacrificial material tube 34 and along the entire length of the sacrificial material tube 34, so that the centre connector 33 and the cylindrical body 28 are electrically connected to each other. The electrical conductor(s) 35, which act as a glow wire for facilitating the formation of a first electrical light arc between the centre connector 33 and the orifice closure 27 or catalyst for the plasma formation, can expediently be comprised of thin wires, wool, rolled foil, mesh structures, porous thin films etc., preferably of metal, for example aluminium, copper, titanium or steel etc. The said fixing of the sacrificial material tube 34 to the ceramic tube 23 is expediently realized by means of a suitable permanent adhesive and by the fact that the sacrificial material tube 34 and the ceramic tube 23 acquire an axial fixing and certain clamping by virtue of the cylindrical body 28 being screwed to the end faces thereof with a certain set force. In order to ensure electrical contact, the threads 29, 30 can be copper-coated and the electrical conductor(s) 35 can be clamped in the said threads 29, 30. As a result of the aforementioned measures, the sensitivity of the plasma generator 4 to shocks and vibrations is also broadly successfully eliminated.

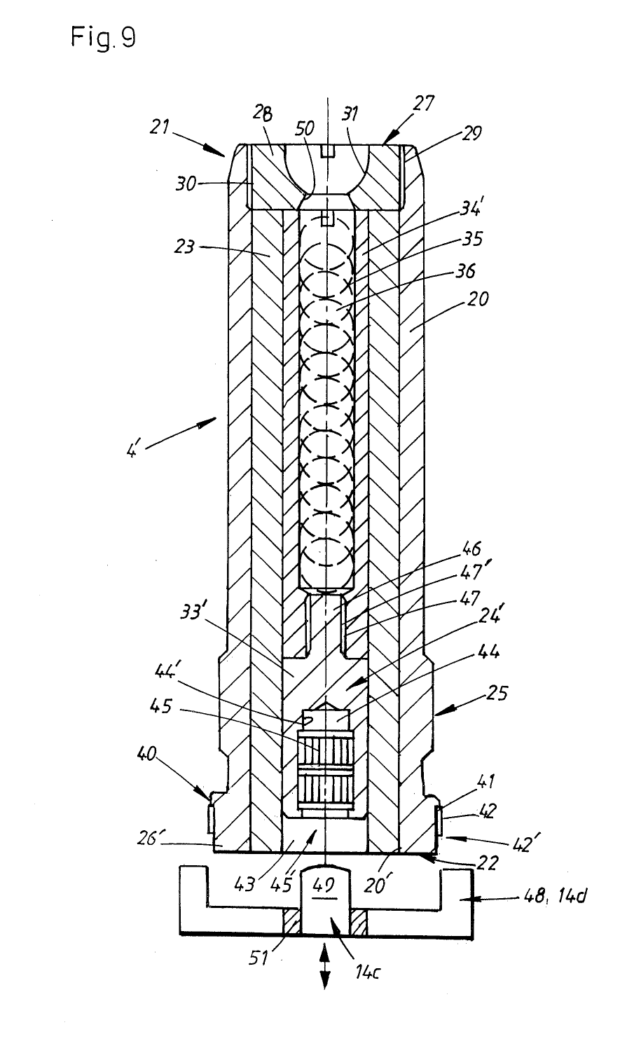

The sacrificial material tube 34 with total thickness t₃₄, t_{34′}, see especially FIG. 11, in which the sacrificial material tube for different components is denoted without ′ for the first embodiment shown in FIG. 4 but with ′ for the second embodiment shown in FIG. 9, is intended, in a coating-by-coating combustion of the same, to be gasified to the extent of one layer or surface coating a1, a2, a3, a4 for each new energy pulse and to release above-explained “lighter” molecules, atoms or ions, which generate a plasma and which facilitate the ignition and the combustion of the propellent charge 6 and maintain and enable the continued plasma process even after the electrical conductors 35 have been consumed.

FIG. 11 thus shows a schematic sacrificial material tube 34, 34′, having a certain total thickness t₃₄, t_{34′}, in which the total tube thickness t₃₄, t_{34′} is shown divided into a number of, here in the specifically shown embodiments, four concentric, theoretical surface coatings or actual layers laminated one on top of the other, labelled jointly for both with a₁, a₂, a₃, a₄. The number of schematically shown surface coatings or layers a₁, a₂, a₃, a₄ in FIG. 11 represents, as explained in greater detail below, either the number of surface coatings which are gasified by the same number of fired energy pulses (in which each of the shown surface coatings also represents the surface coating thickness which is gasified for the respective delivered energy pulse, which delivered energy pulse, and thus also the surface coating thickness belonging thereto, can vary), or the number of actual layers and their thickness which have been predimensioned and have subsequently been combined into an estimated or calculated consumption requirement per delivered energy pulse for a certain type of ammunition shot and ETC weapon.

The total thickness t₃₄, t_{34′} of the sacrificial material 34, 34′, its separate part-thicknesses a₁, a₂, a₃, a₄ and its constituent material choice are therefore precisely dimensioned and selected in order that a thinner surface coating or layer a₁, a₂, a₃, a₄ will always be able to be gasified per delivered electrical energy pulse, whereupon the said sacrificial material 34, 34′ is heated, gasified and ionized coating-by-coating or layer-by-layer a₁, a₂, a₃, a₄ into plasma via the very powerful, electrical energy pulse triggered with a set term, amplitude and shape between the centre electrode 24, 24′ and the annular electrode, i.e. the orifice closure 27, for each such surface coating or layer a₁, a₂, a₃, a₄, a predetermined plasma being made to flow out through the end orifice opening 31 with a very high pressure and at a very high temperature, preferably between about 10,000° K and 30,000° K.

By lighter molecules and atoms is here meant molecules and atoms with low molecular weight, preferably ≦30 u (30 g/mol), from material which, upon combustion, forms molecules and ions which are lighter, i.e. have a lower molecular weight, than the molecules and ions which are formed by the particular electrical conductor(s) 35 and the heavier metal ions ablated from the combustion chamber channel walls in the known plasma generators, and, preferably, from the combustion of the propellent charge 6. One aim of this is that the ionization shall produce electrically charged molecules and/or atoms, which give an improved ignition of the propellent charge 6, and that the formed plasma shall acquire a considerably lower acoustic velocity than that boasted by the conventional propellent gases, thereby producing an advantageous accelerating effect upon the projectile 3.

The sacrificial material tube 34, 34′ therefore comprises at least one sacrificial material, which at least in the formed plasma disintegrates into molecules, atoms or ions in which the sum of the atomic masses for the atoms in the disintegrated molecule (the molecular mass) is preferably lower than about 30 u (g/mol). Such a sacrificial material 34, 34′ expediently contains, for example, hydrogen and carbon, which comfortably meet this condition. The sacrificial material tube 34, 34′ in the embodiments here described in FIG. 4 and FIG. 9 is comprised of at least one dielectric polymer material, preferably a plastic with high melt temperature (preferably over 150° C.), high gasification temperature (over 550° C., preferably over 800° C.) and low thermal conductivity (preferably below 0.3 W/mK). Especially suitable plastics comprise thermoplastics or thermosetting plastics, for example polyethylene, fluoroplastic (such as polytetrafluoroethylene, etc.), polypropylene etc., or polyester, epoxy or polyimides etc., to provide that only one surface coating or layer a₁, a₂, a₃, a₄ of the sacrificial material is gasified for each energy pulse. The sacrificial material 34, 34′ should, preferably, also be sublimating, i.e. pass directly from solid form to gaseous form. It is also conceivable to arrange different layers of material, thickness etc. to form a laminated sacrificial material tube in order to achieve the said coating-by-coating a₁, a₂, a₃, a₄ gasification of the laminate.

The thickness t₃₄, t_{34′} of the sacrificial material tube 34, 34′ is calculated, dimensioned and produced such that only the outermost free surface coating or layer a₁, a₂, a₃, a₄, i.e. that facing out from the surface of the ceramic tube 23 towards the electrical conductors 35, is gasified with each electrical pulse, whereby a plurality of pulses can be generated from the plasma generator 4, 4′ into the cartridge case 2 and onward to the barrel 11, whereupon additional plasma, and thus electrical energy, can be supplied after the first-delivered plasma (see the functional description for greater clarification). Even if the plasma is allowed to cool between the energy pulses, the plasma generator 4, 4′ can still be fired and deliver new light molecules as long as the sacrificial material 34, 34′ remains. It is here worth noting that the ceramic tube 23 prevents the metallic combustion chamber channel 20′ from releasing ions, so that those plasma generators which comprise a ceramic lining utilize a metal wire or an electrically conductive material to initiate the light arc between the electrodes, and once this wire/material has burnt up and the plasma has died down/squirted out of the plasma generator, no new energy pulse can be fired. Optimally, the sacrificial material 34, 34′ must not be consumed until the last electrical energy pulse which is required to be generated to the plasma in order to produce the desired pressure curve inside the barrel 11 is delivered, whereupon the projectile 3 receives its last energy boost, and thus the last increase in pressure and the last increase in acceleration, at the same time as the projectile 3 leaves the barrel muzzle.

By virtue of the fact that the sacrificial material 34, 34′ has such a high gasification temperature and such low thermal conductivity and the chosen sacrificial material 34, 34′ manages, despite considerably longer pulse length, to be gasified only coating-by-coating, or layer-by-layer a₁, a₂, a₃, a₄, for each new electrical energy pulse, a satisfactory solution is obtained to the problems of attaining the desired considerably longer pulse lengths, i.e. pulse lengths longer than 1-10 milliseconds, and the sought-after, appreciably extended plasma life is obtained without the onset of such high temperatures that the plasma generator 4, 4′ is damaged in spite of the ceramic lining/the insert. The fact that the sacrificial material 34, 34′ manages to be gasified only to the extent of one surface coating/layer a₁, a₂, a₃, a₄ for each new energy pulse means that the sought-after, considerably extended plasma life is obtained and the temperature which would otherwise be harmful to the plasma generator 4, 4′ is cooled by the continuous supply of light ions.

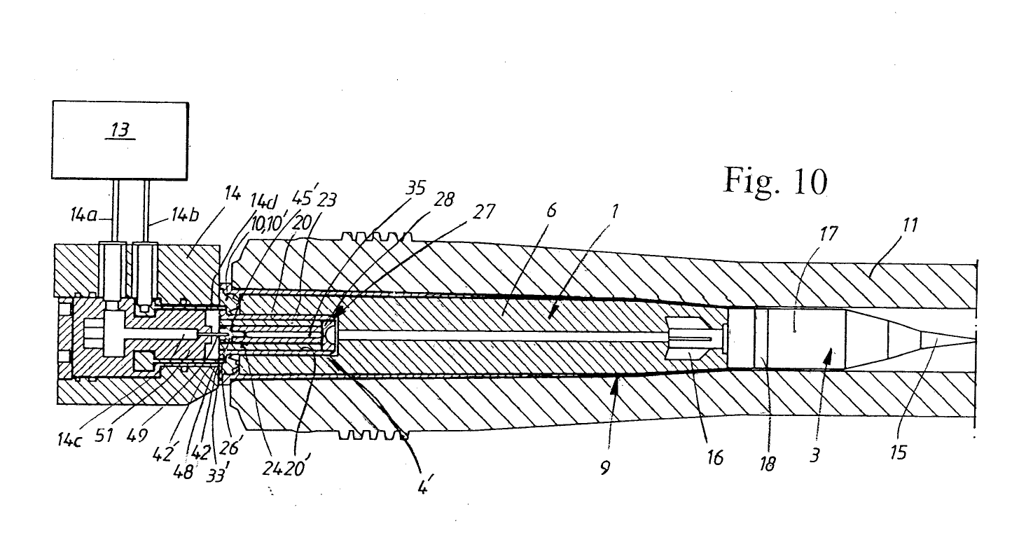

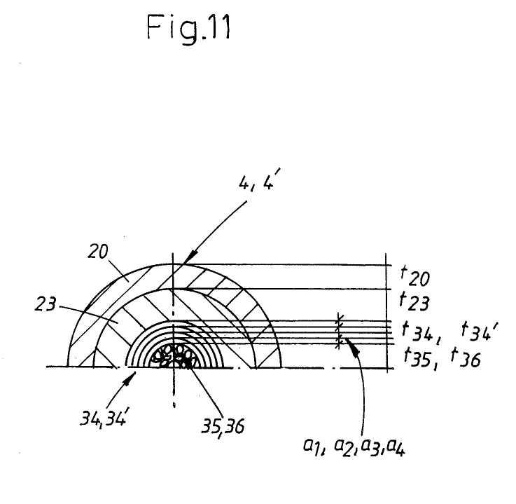

The plasma formation from the dielectric sacrificial material 34, 34′ and the electrical energy supply for the propulsion of the projectile 3 continue throughout the propulsion process by virtue of the fact that the high-voltage source 13 (see especially FIG. 3 and FIG. 10) applies an electrical potential over the dielectric sacrificial material 34, 34′ via (see especially FIG. 4 and FIG. 9) electrodes 28, 33, 33′, i.e. the cylindrical body 28 and the centre connector 33, 33′, at opposite ends of the combustion chamber channel 20′. The total propulsion energy for the projectile 3 therefore receives a substantial energy boost via the supply of extra electrical energy from the high-voltage source 13 via the plasma formed inside the combustion chamber 20. The quantity of plasma which squirts into the cartridge case 2 joins with the ionized propellent charge gases, so that the total quantity of plasma out in the barrel 11 increases in line with the acceleration of the projectile through the whole of the barrel 11, right until the projectile 3 leaves the barrel 11, so that the gas pressure is maintained at the desired barrel pressure throughout this process.

Should a closed electrical circuit be provided between the connectors 33, 33′ of the centre electrode 24, 24′ and an electrode further forward in the barrel 11, then additional energy can be supplied to a plasma there (not shown).

When the invention is used in a combat vehicle, the high-voltage source 13 is expediently applied as comprising an “intermediate store” on the turret, such as a pulse unit 37 in the form of a “rucksack”, see FIG. 5, which is charged in the face of a volley of shots from a “main store” disposed inside the actual combat vehicle.

In the second embodiment of the plasma generator 4′ according to the invention, which is shown in FIG. 9, this second embodiment has substantially all the same components, material choices, characteristics, inclusive of possible combinations thereof, as the first embodiment of the plasma generator 4 which is shown in FIG. 4 and is described in the above text, so that the same reference numerals are used wherever possible below.

The essential differences which are shown in the embodiment according to FIG. 9, and which have in this case received the reference numeral labelled with ′, are, for example, that the metallic combustion chamber 20 has an improved configuration of the flange 26′, which improved flange 26′, along its peripheral rim 40, now comprises a groove 41, in which groove 41 an outer, enclosing lamellar contact strip 42 of conductive material, for example copper, is disposed, for example glued, or otherwise fixed in the groove 41. This unique construction, here comprising the peripheral rim 40 with the groove 41 and the outer lamellar contact strip 42, is hereinafter referred to, for the sake of simplicity, also as the outer lamellar contact 42′.

The outer, enclosing, lamellar contact strip 42, which is somewhat arched and is fitted with its convex side outwards, comprises, in relation to its longitudinal extent, transverse, evenly distributed, continuous, leak-tight gaps for the realization of thin, bridge-shaped lamellae with elastic characteristics for the establishment of a good contact against a therewith interacting female connector 48, shown in FIG. 9 and FIG. 10, disposed in the back piece 14 and acting as the output conductor 14d of the back piece 14, in which female connector 48 the flange 26′ is inserted by a certain set distance, preferably exceeding the flange thickness. The effect of this is that the flange 26′ with the lamellar contact strip 42 and the female connector 48 can move by a shorter distance relative to each other in the axial direction.

The plasma generator 4′ according to this second embodiment, FIG. 9, further comprises a somewhat differently configured centre electrode 24′. The rear metallic centre connector 33′ is in FIG. 9 shown somewhat axially displaced inside the ceramic tube 23 in the direction of the front cylindrical body 28, with the formation of an empty space 43 towards the rear end 22 of the combustion chamber 20, which empty space 43 is intended for the male connector 49 of the back piece 14, i.e. the input conductor 14c (schematically shown in FIG. 9 and FIG. 10). In addition, the said centre connector 33′ comprises a rear centric cavity 44 extending axially inwards, the inner surface 44′ of which cavity 44 is lined with the same type of lamellar contact strip 45, and with corresponding function, as the lamellar contact strip 42 of the flange 26′, yet with the difference that the male connector 49 disposed on the back piece 14, which is schematically shown in FIG. 9 and FIG. 10 and acts as the input conductor 14c, is inserted therein. Here too, in the same way as above, this unique construction, comprising at least the rear centric cavity 44 and the lamellar contact strip 45, but expediently also the empty space 43, is referred to for the sake of simplicity also as the inner lamellar contact 45′ in this text.

The centre connector 33′ in the second embodiment shown in FIG. 9 also comprises a front, threaded pin 46, on which pin 46 the sacrificial material 34′ is threaded by means of a corresponding recess 47 with internal thread 47′. A better securement of the sacrificial material 34′ inside the combustion chamber channel 20′ is then achieved, since any of the plasma jets flowing out of the combustion chamber 20 is otherwise at risk of “blowing” out the sacrificial material 34′ content of the combustion chamber 20. For this reason, the sacrificial material 34′ is additionally glued to the inside of the combustion chamber channel 20′ and is arranged in such a way in relation to the cylindrical body 28 that this body 28 acts as a counterstay for the sacrificial material 34′ and the ceramic tube 23. In the shown second embodiment, the electrical conductors 35 can be inserted in the thread 47′ between the pin 46 and the recess 47, the electrical conductors 35 being held fixed inside the sacrificial material tube 34′. The electrical conductors 35 can additionally be fixed by means of a solidified plastic mass 36, which is most simply poured molten into the sacrificial material tube 34′ and thus encloses the electrical conductors 35 within itself. The sacrificial material tube 34′ can also similarly be poured molten into the ceramic tube 23, solidified around the threaded pin 46 and subsequently bored out for application of the electrical conductors 35 and the solidified plastic mass 36. In the case of a plurality of material layers, this process is repeated such that the desired laminate materializes. All the said fixings of the said components serve to make the plasma generator 4′ very vibration-proof, which has proved a major problem in previously known plasma generator constructions. The solidified plastic mass 36 can be comprised, for example, of stearine, paraffin, glycerine, gelatine etc.

The said, mutually insulated 51 male 49 and female 48 connectors of the back piece 14 (shown only schematically in FIGS. 9 and 10), or the flange 26′ arranged on the plasma generator 4′, comprising the outer, enclosing lamellar contact strip 42, and the centre connector 33′, comprising the rear centric cavity 44 and the inner lamellar contact strip 45, which is fixed there, in similar fashion as for the outer lamellar contact strip 42, against the inner surface 44′ of the cavity 44, thus act as the input and output conductors 14c, 14d of the weapon system, having a comparably larger contact surface than in previous constructions, which new input and output conductors 14c, 14d cope better firstly with normally occurring vibrations, secondly with a relatively large recoil of the weapon, and thirdly with the motions(s) generated with the energy pulse, and thus a minor axial displacement of the connectors 48, 49 of the wedge/the back piece 14 in relation to the outer and inner lamellar contacts 42′, 45′ of the plasma generator 4′ on the flange 26′ and the centre connector 33′, i.e. on its outer and inner lamellar contact strips 42, 45, without the bearing contact and thus the electrical contact being worsened with the recoil, or with other occurring vibration or shock, which worsened contact can be the case where constructions are used which only have contacts of the point-contact or surface-contact type.

In such contacts of the point-contact or surface-contact type, the connectors in each connector pair, which rest one against the other, are at risk of being somewhat separated from each other firstly upon the movements of the weapon, and secondly upon the firing of each energy pulse, whereupon a small clearance can arise between the connector of the back piece and the connector of the plasma generator, which then produces an electrical light arc which threatens to weld the connectors together, especially in the event of particularly high energy transfers. If this welding of the connectors were to occur, it would become impossible for a new ammunition shot to be placed in firing position in the wedge, the back piece etc. In a weapon of this type, it can therefore be difficult to automatically shoot a number of successive ammunition shots over a lengthy period without the weapon seizing up. Even in the case of just one singular energy pulse, the connectors can burn and stick fast if the contact surface is too small and the energy transfer is too large. In the case of large energy transfers, the second embodiment shown in FIG. 9 therefore copes better than the first embodiment shown in FIG. 4, so that the connectors of the first embodiment belonging to the plasma generator 4, and the back piece 14 interacting with the latter, are expediently given a somewhat rounded contact surface shape (not shown), whereby the capacity to perform large energy transfers without major risk of welding is improved.

In the second embodiment shown in FIG. 9, having the unique configuration of the centre connector 33′ and of the flange 26′, comprising the so-called lamellar contacts 42′, 45′ having the lamellar contact strips 42, 45 mounted in the groove 41 and the inner surface 44′ of the rear centric cavity 44, it is possible to automatically shoot a number of successive ammunition shots 1 and also to fire a number of pulses for each such ammunition shot 1 without the clearance and the ensuing light arc materializing between the connectors 48, 49 or the lamellar contacts 42′, 45′ of the back piece 14 and of the plasma generator 4′, which light arc would otherwise normally cause the connectors 48, 49 to threaten to weld together, since the lamellar contacts 42′, 45′, in interaction with the connectors 48, 49, cope easily with normal external vibrations, the recoil, as well as the other vibrations which arise in the particular barrel weapons during use of the plasma generator 4′.

One difference with the configuration of the lamellar contacts 42′, 45′ which is shown in FIG. 9 compared with the first embodiment shown in FIG. 4 is that the lamellar contact strips 42, 45 in FIG. 9 provide the facility for the connectors 48, 49 and the lamellar contact strips 42, 45 to be able to slide relative to each other over a certain axial distance and yet to be in fixed contact by virtue of the sliding surface, interacting between them, of the respective part. This configuration of the contact surface naturally provides a considerably larger contact surface than is the case with the customary contact surfaces of the point-contact or surface-contact type, so that the current transfer is spread over this larger contact surface, so that the current transfer is facilitated and the risk of a light arc is eliminated, thereby preventing welding/burning fast even in the event of a number of pulses.

Functional Description

The production, working and use of the plasma generator 4, 4′ according to the invention is as follows. Compare FIG. 3 and FIG. 4 for the aforementioned first embodiment and FIG. 9 and FIG. 10 in respect of the second described embodiment.

In order to fit the ceramic tube 23 inside the metallic combustion chamber 20, the combustion chamber 20 is first heated to about 550° C., whereafter the ceramic tube 23, which can be cooled, yet not so much that it gets split, is thrust into the combustion chamber channel 20′. When the combustion chamber 20 and the ceramic tube 23 have reached the same temperature, the combustion chamber 20 will have shrunk more than the outer diameter of the ceramic tube 23 at this temperature, so that the ceramic tube 23 is precompressed by the combustion chamber 20. The greater the diameter difference between the outer diameter of the ceramic tube 23 and the diameter of the combustion chamber channel 20′, the greater the precompression. The desired precompression in the ceramic tube 23 can thus both be calculated and obtained.

The centre connector 33, 33′ (expediently cooled in nitrogen to −196° C.) is similarly fitted inside the ceramic tube 23 and, following return to normal temperature, the centre connector 33, 33′ will have expanded to the point where it sits securely fixed inside the ceramic tube 23.

The sacrificial material 34, 34′ is applied either by being glued in the form of a tube, or by being poured in liquid state down into the ceramic tube 23, whereafter the sacrificial material 34, 34′ is expediently bored for reception of the electrical conductors 35, which are expediently wedged in the thread 29, 30 when the cylindrical body 28 is screwed in place. A highly vibration-proof plasma generator has thus been obtained. In the second embodiment, shown in FIG. 9, this has been further improved by an adhesive-coated sacrificial material tube 34′ being inserted inside the ceramic tube 23 and screwed onto the threaded pin 46. The electrical conductors 35 are expediently wedged in the thread 47′ when the centre connector 33′ is screwed onto the threaded pin 46. The sacrificial material tube 34, 34′ is expediently locked in place by the cylindrical body 28, since the nozzle opening 50 of the cylindrical body 28, facing the combustion chamber 20, is smaller than the diameter of the sacrificial material tube 34, 34′. The lamellar contact strips 42, 45 are then fixed firstly in the groove 41 of the flange 26′, and secondly inside the rear centric cavity 44 in the centre connector 33′. Following screwing to the bottom 10′ or bottom piece 10 of the cartridge case 2, an ammunition shot 1 is obtained which is ready for firing and can be loaded into the particular ETC weapon. It will be appreciated that the plasma generator 4, 4′ according to the invention can also be applied in a cartridge-less shot, i.e. where powder bags and projectile are arranged directly in the barrel without a cartridge case, for example only enclosed in the aforementioned shrinkable tubing 12.

Upon firing of an ammunition shot 1, see FIG. 3 and FIG. 10, situated in the wedge/screw piece/back piece 14 of the particular weapon system, the high-voltage source 13 is connected solely via the input and output conductors 14c, 14d of the electrical connections 14a, 14b, i.e. via the connectors 48, 49 of the back piece 14 and, on the one hand, in the first embodiment shown in FIG. 3 and FIG. 4, the connector 33 of the centre electrode 24 and the flange 26 of the combustion chamber 20, and on the other hand, in the second embodiment shown in FIG. 9 and FIG. 10, the lamellar contact 42′ of the flange 26′ and the lamellar contact 45′ of the centre connector 33′.

Other weapon parts are expediently precisely insulated from all contact with the plasma generator 4, 4′. All unwanted imparting of current to the weapon is therefore effectively prevented. The centre connector 33, 33′ and the orifice closure 27 act as an anode and a cathode respectively, which are disposed on opposite ends of the combustion chamber channel 20′ and which are electrically connected to each other via the electrical conductor(s) 35 between them. The transfer of electricity occurs only via the rear end 22 of the plasma generator 4, 4′.

The current/voltage follows the easiest path through the plasma generator 4, 4′, i.e. initially from the input conductor 14c and, in the first embodiment in FIG. 3 and FIG. 4, the connector 33 of the centre electrode 24, or, in the second embodiment in FIG. 9 and FIG. 10, the inner lamellar contact 45′ comprising the rear centric cavity 44 and the lamellar contact strip 45, via the electrical conductors 35 to the cylindrical body, i.e. the annular electrode 28, and then, following combustion of the electrical conductors 35, via the formed, extremely hot plasma, which plasma has very high electrical conductivity due to the ionization of the molecules and the atoms, which molecules, atoms and ions are formed in the gasification of the combustible parts incorporated in the centre electrode 24, 24′, i.e. the sacrificial material tube 34, 34′ and the electrical conductors 35, whereafter the current/voltage is fed back towards the bottom 10′ or bottom piece 10 of the cartridge case 2 via the outer shell of the metallic combustion chamber 20 to, for the first embodiment in FIG. 3 and FIG. 4, the flange 26 on the back part 22 of the combustion chamber 20 and the electrical output conductor and the electrical output conductor 14d disposed there, or, in the second embodiment in FIG. 9 and FIG. 10, the outer lamellar contact 42′, comprising the peripheral rim 40 with the groove 41 and the outer lamellar contact strip 42. As a result of the described construction of the plasma generator 4, 4′, a closed container for the plasma is obtained until the plasma jet is formed, which prevents short-circuiting of the process. The said feedback of the electricity is also facilitated, of course, if the cartridge case 2, and preferably also the bottom 10′ or the bottom piece 10, comprises or is comprised of an electrically insulating material, such as the said fibreglass-reinforced winding epoxy or plastic film coating. The barrel 11 is therefore not live, and at the same time the risk of flash-over/short-circuiting will be very substantially reduced or wholly eliminated.

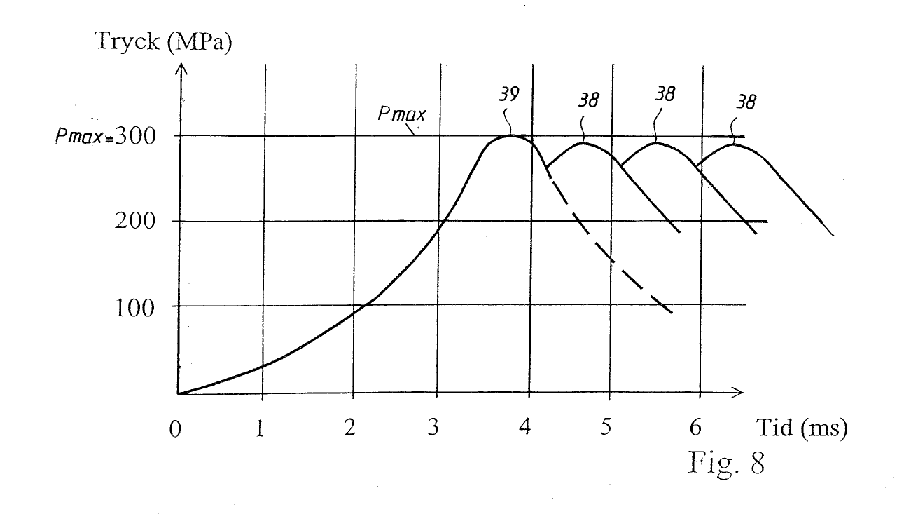

Upon the firing, the high-voltage source 13, for example the said pulse unit 37 (FIG. 5), is made to deliver at least one powerful electrical energy pulse, though preferably a plurality of electrical energy pulses comprising a high current intensity and/or a high voltage, both with a certain set amplitude and length geared to the characteristics applicable to the particular weapon, the shot, the target, the environment, etc. In order to produce an effective plasma in, for example, a medium-calibre weapon (40 mm), each energy pulse should exceed 10 kJ and be supplied to the plasma with a pulse length of around one or a few milliseconds (see especially FIG. 8). Where a pulse unit is used, this comprises capacitors for delivering voltage of about 5-50 kVolt. The current intensity can amount to between 5 and 100 kA, in future even above 100 kA, so that it will be appreciated that the risk of personal injury is high in the event of an unwanted flash-over with current and voltage being imparted to the barrel 11.

The powerful energy pulse(s), preferably about 1-6 energy pulses, heat the electrical conductor(s) 35 to such a high temperature that they melt, are gasified and are finally ionized in a light arc into a very hot first plasma, which thus initially comprises essentially only heavier metal ions from the said electrical conductor(s) 35. The heat from this first plasma gasifies and then, in turn, ionizes an outermost surface coating/layer of the sacrificial material tube 34, 34′, so that the ions and molecules of this surface coating/layer are mixed with the first plasma to form a second, mixed plasma comprising also lighter ions and molecules, and which second plasma, due to the high pressure which is built up inside the ceramic tube 23 and the sacrificial material tube 34, 34′ during the ionization by means of the regularly or intermittently sent energy pulses, is made to squirt out through the end orifice opening 31 in the cylindrical body 28 into the cartridge case 2, in the form of a plasma jet. The interval between the energy pulses, the pulse length, the current intensity, the voltage and the energy boost can be varied according to the particular conditions at the moment of firing, such as ambient temperature, air humidity, etc., and for the specific characteristics of the present weapon system and ammunition type—or projectile type, as well as the particular target type, inclusive of the distance to the said target.

One aim of the sacrificial material tube 34, 34′ is thus that this, in the ionization, shall release electrically charged and therefore electrically conductive particles, compounds, molecules and/or atoms, i.e. ions, which are lighter than those which are obtained in the ionization of the electrical conductors 35, so that, inter alia, an improved ignition of the propellent charge 6 is obtained. With the aid of the plasma generator method which is shown here, it is thus possible to produce a temporally exact ignition of the ammunition shot. It is also possible to temperature-compensate the whole or parts of the pressure deterioration which is obtained when a colder ambient temperature than normal is experienced, and also to reduce the safety margin for a pressure maximum in the dimensioning of the barrel.

The fact that the surface coatings or layers a1, a2, a3, a4 of the sacrificial material tube 34, 34′ release molecules, atoms and ions which are lighter than the heavier metal ions which are formed from the electrical conductors 35 and that the advantageous characteristics of the particular plasma are substantially maintained between the energy pulses, since there is no time to die down or fade to a level which is unfavourable for the ignition and combustion of the propellent charge, gives rise to the aforementioned advantages. In addition, the separate electrical energy pulses will act upon the electrical conductors 35, the inner sacrificial material tube 34, 34′ and the formed plasma in steps. For example, the first energy pulse can produce a gasification and ionization of at least the electrical conductor(s) 35, preferably also a first surface coating/layer a1 from the sacrificial material tube 34, 34′, and an ignition inclusive of commenced gasification of the propellent charge 6 and an ionization of the thereby formed propellent gases, whereafter the following electrical energy pulses, in turn, can gasify and ionize further thin surface coatings/layers a2, a3, a4 of the sacrificial material tube 34, 34′, as well as maintain the already formed plasma and a continued ionization into plasma of the newly formed propellent gas quantities from the progressive combustion of the propellent charge 6 throughout the propulsion through the barrel 11, with no occurrence of an electrical short-circuiting or a reversion from plasma to gaseous form. The plasma, due to its electrical conductivity, is supplied with the desired quantity of electrical energy, which supply is effected via one or more electrical pulses with set wave form and durability, whereby the barrel pressure is maintained at the level optimal for the particular firing throughout the propulsion of the projectile 3 through the whole of the length of the barrel.

This due to the fact, inter alia, that the propellent charge 6 is burnt much more effectively by the pulsed plasma jet, extra energy is supplied etc., as has been explained above. One or more further pressure increases 38, see FIG. 8, will be obtained, one for each additional energy pulse, in addition to the pressure maximum 39, and in FIG. 8 300 MPa is shown as an example of Pₘₐₓ which is obtained in a comparable conventional ignition. When an ammunition shot 1 is fired, the individual pressure curves 38, 39 from each of the imparted electrical pulses mutually overlap, such that the total pressure curve which is obtained for the particular barrel 11 is always just less than the permitted maximum pressure of the barrel, at the same time as the pressure troughs of the total pressure curve are minimized.

Two principal ways exist of executing the coating-by-coating, or layer-by-layer a1, a2, a3, a4, burning-off of the sacrificial material.

Firstly, the coating-by-coating a1, a2, a3, a4 burning-off can be realized on the basis of the energy boost if required, and which in this case is expediently detected via suitable sensors, at the moment of the energy pulse, in order to compensate for the particular pressure reduction in the barrel at the said moment. The gasified surface coating thickness a1, a2, a3, a4 then corresponds to the required energy boost for getting back up to Pₘₐₓ.

The second implementation is, on the basis of weapon, ammunition type, target etc., to previously build up the sacrificial material in defined layers a1, a2, a3, a4 with respect to material and desired characteristics, so that each such layer a1, a2, a3, a4, given an individualized energy pulse at a certain predefined pulse interval, provides the desired energy boost for the maintenance of Pₘₐₓ, i.e. the thicknesses of the layers a1, a2, a3, a4 are determined at the time of the energy pulses fired at a certain interval, so that a pre-estimated pressure increase to Pₘₐₓ is achieved.

### Illustrative Embodiments

In varying illustrative embodiments of a plasma generator according to the invention, intended for a 40 mm ammunition shot, ceramic tubes having an outer diameter of about 14-20 mm and a tube thickness of about 2-6 mm are used, as well as sacrificial material tubes of various polymer materials and thicknesses, which are disposed in these ceramic tubes. The said sacrificial material tubes were here specifically dimensioned to thicknesses of about 1-6 mm, whereby a coating-by-coating gasification of the sacrificial material tube was achieved during a number of successively fired energy pulses of about 10-100 kJ with a length of around one to a few milliseconds per pulse and with a voltage of up to about 50 kVolt. The current intensity was normally between 5 and 100 kA, but above 100 kA is also conceivable, and a barrel pressure of about 400-500 MPa was attained, which was maintained substantially continuously throughout the propulsion process.

### Alternative Embodiments

The invention is not limited to the specifically shown embodiments, but can be variously modified within the scope of the patent claims.

It will be appreciated, for example, that the number, size, material and shape of the elements and components which make up the ammunition shot and the plasma generator are geared to the weapon system(s) and other design characteristics present at the time.

It will be appreciated that the above-described ETC ammunition can comprise a number of different dimensions and projectile types depending on the field of application and the barrel width. Hereabove, however, allusion is made to at least the currently most common ammunition types of between about 25 mm and 160 mm.

In the above-described embodiments, the plasma generator comprises only a front opening for a plasma jet, but it falls within the inventive concept to provide more such openings along the surface of the combustion chamber.

In addition to the electrically insulated cartridge case, it is conceivable to also provide an additional insulation of the actual plasma generator by means of a non-conductive material applied to the outside of the combustion chamber.

The above-described invention can also be configured for possible use to shoot automatic fire, both with respect to the plasma generator configuration with two separate connectors/surfaces for direct electrical connection of each individual ammunition shot to the particular weapon system via its back piece and there-disposed corresponding connectors/surfaces in the wedge of the back piece, i.e. the wedge which acts as a counterstay when the shot is fired and which bears directly against the bottom of the ammunition shot in the wedge.

1. Plasma generator for electrothermal and electrothermal-chemical weapon systems, which plasma generator is intended to deliver at least one energy pulse for the formation of a plasma for accelerating a projectile along the barrel of the weapon system, which plasma generator comprises a combustion chamber having an axial combustion chamber channel, a centre electrode disposed inside the combustion chamber channel, which combustion chamber and centre electrode are electrically conductive, as well as a ceramic tube, arranged between the combustion chamber and the centre electrode disposed inside the combustion chamber, for insulating the centre electrode from the combustion chamber, wherein the ceramic tube is precompressed via a shrink-fastening and in that the plasma generator further comprises at least one polymeric sacrificial material, which is gasifiable by the at least one energy pulse and which is disposed inside the ceramic tube.

2. Plasma generator according to claim 1, wherein the sacrificial material is gasifiable only to the thickness of one surface coating or layer via the delivered at least one energy pulse.

3. Plasma generator according to claim 2, wherein the sacrificial material is gasifiable to the thickness of a further surface coating or layer for each new energy pulse.

4. Plasma generator according to claim 1, wherein the sacrificial material has a total thickness which is divided into a number of separate, concentric layers laminated one on top of the other, which number of layers and their thickness, material and desired characteristics are dimensioned and selected and preassembled into a laminated sacrificial material tube according to an estimated consumption requirement per delivered energy pulse for a certain type of ammunition shot and ETC weapon for the attainment of a layer-by-layer gasification of the laminated sacrificial material tube.

5. Plasma generator according to claim 1, wherein the sacrificial material is gasifiable for at least the period for which the plasma is maintained or newly created via new energy pulses.

6. Plasma generator according to claim 1, wherein the sacrificial material is gasifiable for at least the whole of the period for which the projectile is propelled through the barrel.

7. Plasma generator according to claim 1, wherein the gasifiable polymeric sacrificial material is comprised of at least one material which in the formed plasma disintegrates into ions, in which the sum of the atomic masses for the atoms in the formed ion (the molecular mass) is lower than or equal to 30 u (30 g/mol).

8. Plasma generator according to claim 1, wherein the at least one gasifiable polymeric sacrificial material is comprised of a material which in the formed plasma forms electrically charged particles with a mass which is lower than or equal to 30 u, i.e. the formed ions have an atomic or molecular mass≦30 g/mol.

9. Plasma generator according to claim 1, wherein the gasifiable polymeric sacrificial material is comprised of at least one dielectric material comprising hydrocarbons, for example thermoplastics, for example polyethylene, fluoroplastic (such as polytetrafluoroethylene, etc.) etc., polypropylene or thermosetting plastics, such as polyester, epoxy or polyimides etc.

10. Plasma generator according to claim 1, wherein the gasifiable polymeric sacrificial material has a melt temperature of at least 150° C.

11. Plasma generator according to claim 1, wherein the gasifiable polymeric sacrificial material has a gasification temperature of at least 550° C., preferably over 800° C.

12. Plasma generator according to claim 1, wherein the gasifiable polymeric sacrificial material has a thermal conductivity of no higher than 0.3 W/mK.

13. Plasma generator according to claim 1, wherein the sacrificial material has a thickness of about 1-6 mm.

14. Plasma generator according to claim 1, wherein the centre electrode is disposed inside the ceramic tube, and which centre electrode, in addition to the at least one gasifiable polymeric sacrificial material, comprises firstly an electrically conductive centre connector, and secondly at least one electrical conductor arranged between the front end of the combustion chamber and the centre connector.

15. Plasma generator according to claim 14, wherein the centre connector also comprises a front pin, on which pin the sacrificial material is fixed.

16. Plasma generator according to claim 1, wherein the centre connector is fitted inside the rear part of the ceramic tube via a shrink-fit.

17. Plasma generator according to claim 1, wherein the gasifiable polymeric sacrificial material is comprised of at least one material which m the formed plasma forms ions which have a lower molecular mass than the heavier metal ions formed by the at least one electrical conductor.

18. Plasma generator according to claim 1, wherein the sacrificial material is disposed along a specific part of the centre electrode, preferably between the front end of the combustion chamber and the centre connector.

19. Plasma generator according to claim 1, wherein the sacrificial material is fixed against the ceramic tube by means of an adhesive.

20. Plasma generator according to claim 1, wherein the sacrificial material is comprised of at least one mass which, in at least one cylindrical surface coating or layer is solidified in the combustion chamber channel, which at least one mass comprises a space for at least one electrical conductor.

21. Plasma generator according to claim 1, wherein at least one electrical conductor is enclosed and fixed in a plastic mass.

22. Plasma generator according to claim 1, wherein the plasma generator comprises an axially disposed end orifice opening for the delivery of a singular axial plasma jet out of the combustion chamber of the plasma generator.

23. Plasma generator according to claim 1, wherein the ceramic tube and the sacrificial material are axially fixed and axially clamped in the combustion chamber channel via a body comprising the end orifice opening.

24. Plasma generator according to claim 1, wherein the plasma generator comprises a plurality of openings arranged radially along the shell surface of the combustion chamber for a radial delivery of plasma jets out of the combustion chamber of the plasma generator.

25. Plasma generator according to claim 1, wherein the sacrificial material is sublimating.

26. Method for making a plasma generator for electrothermal and electrothermal-chemical weapon systems from at least one plasma, which plasma is intended to accelerate a projectile along the barrel of the weapon system, which plasma generator has been produced with a combustion chamber having an axial combustion chamber channel, a centre electrode having been disposed inside the combustion chamber channel, which combustion chamber and centre electrode are electrically conductive, and a ceramic tube for insulating the centre electrode from the combustion chamber having been arranged between the combustion chamber and the centre electrode disposed inside the combustion chamber, wherein the plasma is formed by at least one delivered energy pulse gasifying at least one surface coating or layer of a polymeric sacrificial material which has been disposed inside the ceramic tube, which ceramic tube has been shrank-fastened and hence precompressed to withstand a number of successive energy pulses.

27. Method according to claim 26, wherein the plasma is maintained or newly created by further sacrificial material being gasified via new energy pulses.

28. Method according to claim 26, wherein the thickness and material characteristics of the sacrificial material, such as its gasification temperature and thermal conductivity, have been chosen such that only a certain surface coating or number of layers is converted into plasma per electrical energy pulse.

29. Method according to claim 26, wherein the plasma is maintained or newly created by the sacrificial material being gasified via new energy pulses at least throughout the period in which the projectile is propelled through the barrel.

30. Method according to claim 26, wherein the number of energy pulses, the interval between the energy pulses, the pulse length, the current intensity and the voltage which are utilized during the course of propulsion of the projectile through the barrel are varied according to the particular conditions at the moment of firing, whereby an energy supplied to the plasma is controlled.

31. Method according to claim 30, wherein a pressure deterioration which occurs at a disadvantageous temperature is actively compensated via the supplied energy, whereby a desired temperature and pressure can be attained according to the particular requirements of the existing ambient and propulsion gases.

32. Method according to claim 26, wherein the plasma generator supplies an energy boost which is geared to and is added to a chemical energy which is obtained upon combustion of a propellent charge, so that the supplied energy and the obtained chemical energy together achieve the quantity of energy which is required in order to achieve and maintain a specific barrel pressure for the particular weapon system during the course of propulsion of the projectile through the barrel.

33. Method according to claim 32, wherein the thickness of the surface coating converted into the plasma is corresponded to by the energy boost which is required at the energy pulse moment to compensate for the particular pressure reduction in the barrel at the said moment in order to regain the set barrel pressure for the barrel.

34. Method according to claim 32, wherein the sacrificial material (34, 34′) is built up in advance in defined layers with respect to material and desired characteristics, in that each such layer, given a tailor-made energy pulse at a certain predefined pulse interval, provides a desired energy boost for maintaining the set barrel pressure for the barrel.

35. Method according to claim 32, wherein the set barrel pressure is constituted by the maximally permitted barrel pressure for the barrel.

36. Method according to claim 26, wherein the sacrificial material is poured in liquid state into the ceramic tube, whereafter the sacrificial material is solidified.

37. Method according to claim 36, wherein an axial recess is created in the solidified sacrificial material tube.

38. Method according to claim 37, wherein new sacrificial material is applied and is solidified in the recess inside the previously applied sacrificial material, whereafter a new axial recess is created in the last applied sacrificial material, which process is repeated until a desired number of layers of sacrificial material has been created.

39. Method according to claim 37, wherein the axial recess m the sacrificial material is created by the liquid sacrificial material solidifying around a pull-out element, or by boring.

40. Method according to claim 26, wherein at least one electrical conductor has been disposed inside the ceramic tube along the entire length of the sacrificial material, so that an electrical connection is created over the entire length of the ceramic tube.

41. Method according to claim 40, wherein the first energy pulse converts at least the at least one electrical conductor into plasma, in that the following energy pulses convert at least one outer surface coating or layer of the sacrificial material into further plasma, whereby a number of successive energy pulses are generated from the plasma generator even after the electrical conductors have been consumed.

42. Method according to claim 26, wherein the plasma is made to flow out of the plasma generator with a pressure of between about 200 and 1000 MPa and with a temperature between about 10,000° K and 30,000° K.

43. Method according to claim 26, wherein each energy pulse is of at least 10 kJ and is supplied to the plasma with a pulse length of at least 1-10 milliseconds per energy pulse.

44. Method according to claim 26, wherein each energy pulse has a voltage of about 5-50 kVolt.

45. Method according to claim 26, wherein each energy pulse has a current intensity of between 5 and 100 kA.

46. Ammunition shot comprising a plasma generator for electrothermal and electrothermal-chemical weapon systems, which plasma generator is intended to deliver at least one energy pulse for the formation of a plasma for accelerating a projectile along the barrel of the weapon system, which plasma generator comprises a combustion chamber having an axial combustion chamber channel, a centre electrode disposed inside the combustion chamber channel, which combustion chamber and centre electrode are electrically conductive, as well as a ceramic tube, arranged between the combustion chamber and the centre electrode disposed inside the combustion chamber, for insulating the centre electrode from the combustion chamber, wherein the ammunition shot comprises a plasma generator according to claim 1.

47. Ammunition shot comprising a plasma generator for electrothermal and electrothermal-chemical weapon systems, which plasma generator is intended to deliver at least one energy pulse for the formation of a plasma for accelerating a projectile along the barrel of the weapon system, which, plasma generator comprises a combustion chamber having an axial combustion chamber channel, a centre electrode disposed inside the combustion chamber channel, which combustion chamber and centre electrode are electrically conductive, as well as a ceramic tube, arranged between the combustion chamber and the centre electrode disposed inside the combustion chamber, for insulating the centre electrode from the combustion chamber, wherein the ammunition shot comprises a plasma generator which is intended to form at least one plasma by means of a method according to claim 26.
